(19) United States
(12) Patent Application Publication
(10) Pub. No.: US 2025/0039784 A1
(43) Pub. Date: Jan. 30, 2025

(54) METHODS AND WIRELESS NETWORK FOR SIGNALLING ACTIVATION AND DEACTIVATION INDICATION OF CELL-DTX/CELL-DRX CONFIGURATIONS FOR NES

(71) Applicant: Samsung Electronics Co., Ltd., Suwon-si (KR)

(72) Inventors: Vinay Kumar SHRIVASTAVA, Bengaluru (IN); Diwakar SHARMA, Bengaluru (IN); Sriganesh RAJENDRAN, Bengaluru (IN)

(21) Appl. No.: 18/781,259

(22) Filed: Jul. 23, 2024

(30) Foreign Application Priority Data
Jul. 28, 2023 (IN) 202341051099
Aug. 11, 2023 (IN) 202341053874
Jul. 12, 2024 (IN) 2023 41051099

(51) Int. Cl. H04W 52/02; H04W 76/28

(52) U.S. Cl. CPC H04W 52/0206; H04W 76/28

(57) ABSTRACT

The disclosure relates to a fifth generation (5G) or sixth generation (6G) communication system for supporting a higher data transmission rate. A method for handling network energy saving (NES) in a wireless network is provided. The method includes receiving, by a user equipment (UE) a radio resource control (RRC) reconfiguration message from a network entity, wherein the RRC reconfiguration message includes at least one of a cell discontinuous reception (Cell-DRX) configuration and a cell discontinuous transmission (Cell-DTX) configuration for at least one serving cell, performing at least one of an activation and deactivation for at least one of the Cell-DRX configuration and the Cell-DTX configuration by at least one of the RRC reconfiguration message and a downlink control information (DCI) termed as DCI X, and handling the NES in the wireless network upon performing at least one of the activation and deactivation for at least one of the Cell-DRX configuration and the Cell-DTX configuration.

### CROSS REFERENCE TO RELATED APPLICATION

This application is based on and claims priority under 35 U.S.C. § 119 (a) of an Indian Provisional patent application number 202341051099, filed on Jul. 28, 2023, in the Indian Patent Office, of an Indian Provisional patent application number 202341053874, filed on Aug. 11, 2023, in the Indian Patent Office, and of an Indian Complete patent application No. 202341051099, filed on Jul. 12, 2024, in the Indian Patent Office, the disclosure of each of which is incorporated by reference herein in its entirety.

### BACKGROUND

### 1. Field

The disclosure relates to a wireless network. More particularly, the disclosure relates to a method, a user equipment (UE), and a network entity for signaling activation and deactivation indication of a cell discontinuous reception (Cell-DRX) configuration and a cell discontinuous transmission (Cell-DTX) configuration for network energy saving (NES) in the wireless network.

### 2. Description of Related Art

Fifth generation (5G) mobile communication technologies define broad frequency bands such that high transmission rates and new services are possible, and can be implemented not only in “Sub 6 GHz” bands, such as 3.5 GHz, but also in “Above 6 GHz” bands referred to as millimeter wave (mmWave) including 28 GHz and 39 GHz. In addition, it has been considered to implement sixth generation (6G) mobile communication technologies (referred to as beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced mobile broadband (eMBB), ultra reliable low latency communications (URLLC), and massive machine-type communications (mMTC), there has been ongoing standardization regarding beamforming and massive multiple-input multiple-output (MIMO) for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods, such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies, such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, new radio (NR) UE power saving, non-terrestrial network (NTN) which is UE-satellite direct communication for providing coverage in an area in which communication with terrestrial networks is unavailable, and positioning.

Moreover, there has been ongoing standardization in air interface architecture/protocol regarding technologies, such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step random access channel (RACH) for NR). There also has been ongoing standardization in system architecture/service regarding a 5G baseline architecture (for example, service based architecture or service based interface) for combining network functions virtualization (NFV) and software-defined networking (SDN) technologies, and mobile edge computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR) and the like, 5G performance improvement and complexity reduction by utilizing artificial intelligence (AI) and machine learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies, such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and artificial intelligence (AI) from the design stage and internalizing end-to-end AI support functions, and next-generation distributed computing technology for implementing services at levels of complexity exceeding the limit of UE operation capability by utilizing ultra-high-performance communication and computing resources.

Network energy saving (NES) has become one of the most significant aspects recently considering the ever increasing power consumption by a wireless network that serves billions of user equipment's (UEs), and the associated high cost involved. The transmission and the reception, by a radio access network (RAN) nodes, typically account for around 22 percent of the overall power consumption by the communication networks. For enabling energy efficient networks operations, there is a need for efficient approaches that can achieve energy savings for the wireless networks. Some of these approaches may include a special operation mode (for example, termed as NES mode) wherein network nodes (or network entity) may apply discontinuous transmission (DTX) and/or discontinuous reception (DRX) to curtail power consumption by the network nodes.

One potential issue with the NES approaches relates to how to signal activation/deactivation indication for Cell-DTX and/or Cell-DRX configuration(s) for one or more serving cells. The signaling approach is required to be efficient from the perspective of the signaling overhead and also be reliable, e.g., to ensure no loss of data due to missing of activation indication or unnecessary power consumption due to missing of deactivation indication.

Thus, it is desired to address the above mentioned disadvantages or other shortcomings or at least provide a useful alternative.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide methods and a wireless network for signaling activation and deactivation of Cell-DTX/Cell-DRX configurations for network energy savings (NES).

Another aspect of the disclosure is to receive, by a UE, a radio resource control (RRC) reconfiguration message from a network entity, where the RRC reconfiguration message includes at least one of a cell discontinuous reception (Cell-DRX) configuration and a cell discontinuous transmission (Cell-DTX) configuration for at least one serving cell.

Another aspect of the disclosure is to perform, by the UE, at least one of an activation and deactivation for at least one of the Cell-DRX configuration and the Cell-DTX configuration by at least one of the RRC reconfiguration message and a downlink control information (DCI) termed as DCI X.

Another aspect of the disclosure to handle, by the UE, the NES in the wireless network upon performing at least one of the activation and deactivation for at least one of the Cell-DRX configuration and the Cell-DTX configuration.

Additional aspects will be set forth in part in the description which follows and, in part, will be apparent from the description, or may be learned by practice of the presented embodiments.

In accordance with an aspect of the disclosure, a method for handling NES in a wireless network is provided. The method includes receiving, by a user equipment (UE), an RRC reconfiguration message from a network entity, wherein the RRC reconfiguration message includes at least one of a Cell-DRX configuration and a Cell-DTX configuration for at least one serving cell, performing, by the UE, at least one of an activation and deactivation for at least one of the Cell-DRX configuration and the Cell-DTX configuration by at least one of the RRC reconfiguration message and a DCI termed as DCI X, and handling, by the UE, the NES in the wireless network upon performing at least one of the activation and deactivation for at least one of the Cell-DRX configuration and the Cell-DTX configuration.

In an embodiment of the disclosure, the bitmap is provided in the DCI X for at least one of the activation and deactivation for at least one of the Cell-DRX configuration and the Cell-DTX configuration.

In an embodiment of the disclosure, the DCI X is at least one of: a common DCI and a group common DCI, where the DCI X is a DCI format 2_9.

In an embodiment of the disclosure, the at least one of the common DCI and the group common DCI is utilized by the network entity for activation of at least one of: the Cell-DRX configuration and the Cell-DTX configuration and deactivation of at least one of the Cell-DRX configuration and Cell-DTX configuration.

In an embodiment of the disclosure, each bit of the bitmap maps to at least one of: the Cell-DRX configuration and the Cell-DTX configuration, where the bitmap includes a 1 bit or 2 bits for at least one of: the Cell-DRX configuration and Cell-DTX configuration.

In an embodiment of the disclosure, at least one of: the cell-DRX configuration and the cell-DTX configuration is activated at a time for the at least one serving cell.

In an embodiment of the disclosure, different configuration of at least one of: the cell-DRX configuration and the cell-DTX configuration is activated at a time for different serving cells.

In an embodiment of the disclosure, an activation indication and a deactivation indication for at least one of: the cell-DRX configuration and the Cell-DTX configuration for the at least one serving cell received in the DCI X is applied at a time offset as an activation time and a deactivation time after a reception of the DCI X.

In an embodiment of the disclosure, at least one of: the activation time and the deactivation time is pre-specified, wherein the at least one of: the activation time and the deactivation time corresponds to a minimum time gap value after the reception of DCI X, wherein minimum time gap is pre-specified as N slots after the reception of DCI X.

In an embodiment of the disclosure, specific UEs or a group of UEs commonly receive the activation of signalling and deactivation of signalling, wherein the UE or the group of UEs is dedicatedly configured for a pre-configured occasion of the DCI, wherein the pre-configured occasion is one of post on-duration start by an offset within a DRX on-duration period or before on-duration start by an offset.

In an embodiment of the disclosure, the DCI X is addressed to a NES Radio Network Temporary Identifier (NES-RNTI), wherein a group common Physical Downlink Control Channel (PDCCH) carrying the DCI X is scrambled with the NES-RNTI.

In an embodiment of the disclosure, the DCI X carries at least one of: the bit, the bitmap, a code-point, and a field that corresponds activation or deactivation indication to the at least one of the cell-DRX and the cell-DTX configuration.

In an embodiment of the disclosure, the configuration of an activation indication and the configuration of the deactivation indication is to be monitored in correspondingly configured PDCCHs of the at least one serving cell.

In an embodiment of the disclosure, position in the DCI X of the bit field that indicates at least one of: activation and deactivation of the at least one of: the Cell-DRX configuration and the Cell-DTX configuration for the at least one serving cell is given by parameter positionInDCI-cellDTRX, wherein a starting position of a block associated with the at least one serving cell is determined by a parameter positionInDCI-cellDTRX provided by a higher layer for the UE.

In an embodiment of the disclosure, a size of the DCI X is configurable by a higher layer up to a specified number of bits.

In accordance with another aspect of the disclosure, a method for handling a NES in a wireless network is provided. The method includes sending, by a network entity, an RRC reconfiguration message to a UE, wherein the RRC reconfiguration message includes at least one of: a Cell-DRX configuration and a Cell-DTX configuration for at least one serving cell, performing, by the network entity, at least one of an activation and deactivation for at least one of the Cell-DRX configuration and the Cell-DTX configuration by at least one of the RRC reconfiguration message and a DCI termed as DCI X and handling, by the network entity, the NES in the wireless network upon performing at least one of the activation and deactivation for at least one of the Cell-DRX configuration and the Cell-DTX configuration.

In accordance with another aspect of the disclosure, a UE is provided. The UE includes a processor, memory, and a NES controller coupled with the processor and the memory, configured to receive an RRC reconfiguration message from a network entity, wherein the RRC reconfiguration message includes at least one of a Cell-DRX configuration and a Cell-DTX configuration for at least one serving cell, perform at least one of an activation and deactivation for at least one of the Cell-DRX configuration and the Cell-DTX configuration by at least one of the RRC reconfiguration message and a DCI termed as DCI X, and handle the NES in the wireless network upon performing at least one of the activation and deactivation for at least one of the Cell-DRX configuration and the Cell-DTX configuration.

In accordance with another aspect of the disclosure, a network entity is provided. The network entity includes a processor, memory, and a NES controller coupled with the processor and the memory configured to send an RRC reconfiguration message to a UE, wherein the RRC reconfiguration message includes at least one of a Cell-DRX configuration and a Cell-DTX configuration for at least one serving cell, perform at least one of an activation and deactivation for at least one of the Cell-DRX configuration and the Cell-DTX configuration by at least one of: the RRC reconfiguration message and a DCI termed as DCI X, and handle the NES in the wireless network upon performing at least one of the activation and deactivation for at least one of the Cell-DRX configuration and the Cell-DTX configuration.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an overview of a wireless network for handling network energy saving (NES) according to an embodiment of the disclosure;

FIG. 2 shows various hardware components of a user equipment (UE) according to an embodiment of the disclosure;

FIG. 3 shows various hardware components of a network entity according to an embodiment of the disclosure;

FIG. 4 is a flowchart illustrating a method for receiving and applying a Cell-DRX and/or Cell-DTX configurations for one or more serving cells according to an embodiment of the disclosure;

FIG. 5 is a flowchart illustrating a method for receiving and applying a Cell-DRX and/or Cell-DTX configurations for the one or more serving cells according to an embodiment of the disclosure;

FIG. 6 is a flowchart illustrating a method for receiving and applying a Cell-DRX and/or Cell-DTX configurations for the one or more serving cells according to an embodiment of the disclosure;

FIG. 7 is a flowchart illustrating a method for receiving and applying activation/deactivation indication for a Cell-DRX and/or Cell-DTX configurations for one or more serving cells according to an embodiment of the disclosure;

FIG. 8 is a flowchart illustrating a method for receiving and applying activation/deactivation indication for a Cell-DRX and/or Cell-DTX configurations for one or more serving cells according to an embodiment of the disclosure;

FIG. 9 is a flow chart illustrating a method, implemented by a UE, for handling NES in a wireless network, according to an embodiment as of the disclosure; and

FIG. 10 is a flow chart illustrating a method, implemented by a network entity, for handling NES in a wireless network, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the disclosure. Furthermore, in terms of the construction of the device, one or more components of the device may have been represented in the drawings by symbols of the related art, and the drawings may show only those specific details that are pertinent to understanding the embodiments of the disclosure so as not to obscure the drawings with details that will be readily apparent to those of ordinary skill in the art having the benefit of the description herein.

In addition, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

The words/phrases “exemplary”, “example”, “illustration”, “in an instance”, “and the like”, “and so on”, “etc.”, “etcetera” are merely used herein to mean “serving as an example, instance, or illustration.” Any embodiment or implementation of the subject matter described herein using the words/phrases “exemplary”, “example”, “illustration”, “in an instance”, “and the like”, “and so on”, “etc.”, “etcetera” is not necessarily to be construed as preferred or advantageous over other embodiments.

Various embodiments herein may be described and illustrated in terms of blocks which carry out a described function or functions. These blocks, which may be referred to herein as managers, units, modules, hardware components or the like, are physically implemented by analog and/or digital circuits, such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports, such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by symbols of the related art, and the drawings may show only those specific details that are pertinent to understanding the embodiments so as not to obscure the drawings with details that will be readily apparent to those of ordinary skill in the art having the benefit of the description herein. Furthermore, in terms of the system, one or more components/modules which comprise the system may have been represented in the drawings by symbols of the related art, and the drawings may show only those specific details that are pertinent to understanding the embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the disclosure should be construed to extend to any modifications, equivalents, and substitutes in addition to those which are particularly set out in the accompanying drawings and the corresponding description. Usage of words, such as first, second, third etc., to describe components/elements/steps is for the purposes of this description and should not be construed as sequential ordering/placement/occurrence unless specified otherwise.

The embodiments herein achieve a method for handling NES in a wireless network. The method includes receiving, by a UE, an RRC reconfiguration message from a network entity. The RRC reconfiguration message includes at least one of: a Cell-DRX configuration and a Cell-DTX configuration for at least one serving cell. Further, the method includes performing, by the UE, at least one of an activation and deactivation for at least one of the Cell-DRX configuration and the Cell-DTX configuration by at least one of: the RRC reconfiguration message and a DCI termed as DCI X. Further, the method includes handling, by the UE, the NES in the wireless network upon performing at least one of the activation and deactivation for at least one of the Cell-DRX configuration and the Cell-DTX configuration.

The method can be used for signaling activation and deactivation of Cell-DTX/Cell-DRX configurations for the NES in an efficient and a reliable manner. The proposed method reduces the network energy consumption cost with the discontinuous transmission and discontinuous reception employed by the network node(s) and thereby, the configured UE(s).

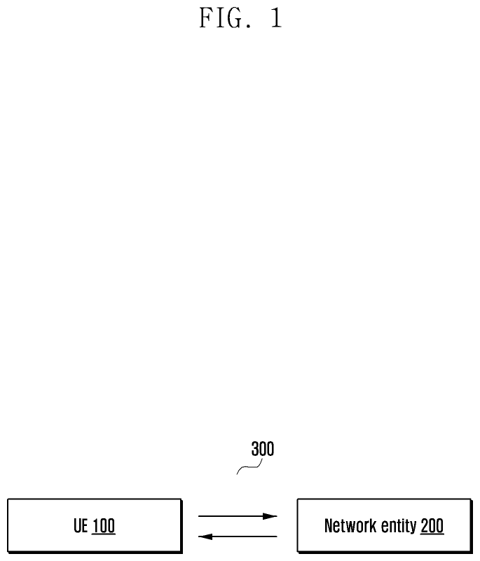

Referring now to the drawings, and more particularly to FIGS. 1 through 10, where similar reference characters denote corresponding features consistently throughout the figures, there are shown at least one embodiment.

It should be appreciated that the blocks in each flowchart and combinations of the flowcharts may be performed by one or more computer programs which include computer-executable instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g., a central processing unit (CPU)), a communication processor (CP, e.g., a modem), a graphical processing unit (GPU), a neural processing unit (NPU) (e.g., an artificial intelligence (AI) chip), a wireless-fidelity (Wi-Fi) chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an IC, or the like.

FIG. 1 illustrates an overview of a wireless network for handling NES according to an embodiment of the disclosure.

Referring to FIG. 1, in an embodiment of the disclosure, the wireless network 300 includes a UE 100 and a network entity 200. The wireless network 300 can be, for example, but not limited to a fourth generation (4G) network, a fifth generation (5G) network, a sixth generation (6G) network, an open radio access network (ORAN) or the like.

The UE 100 can be, for example, but not limited to a laptop, a desktop computer, a notebook, a device-to-device (D2D) device, a vehicle to everything (V2X) device, a smartphone, a foldable phone, a smart TV, a tablet, a server, an IoT device, an augmented reality (AR) device, a mixed reality (MR) device, a virtual reality (VR) device, an immersive device, an XR device, a metaverse device or the like. The network entity 200 can be, for example, but not limited to a base station, a next generation node B (gNB), an evolved node B (eNB), a transmit receive point (TRP), a 5G or 6G transceiver, or the like.

In an embodiment of the disclosure, the network entity 200 configures the UE 100 for NES configurations through an RRC signalling message e.g., an RRC Reconfiguration message. The NES configuration comprises the configuration(s) for Cell-DRX and/or configuration(s) for Cell-DTX for one or more serving cells. For example, multiple configurations can be provided for the Cell-DRX and/or Cell-DTX to the UE 100. Each of the Cell-DRX and/or Cell-DTX configurations can be explicitly assigned an index or implicitly mapped to an index; (for example) in the order of the Cell-DRX and/or Cell-DTX configurations present in the RRC reconfiguration. Each of the Cell-DRX and/or Cell-DTX configurations is applicable for at least one serving cell or a specific serving cell.

In an embodiment of the disclosure, the network entity 200 can broadcast the NES configuration as part of an existing system information block message (such as SIB1) or as part of a new NES specific system information message SIBx.

In an embodiment of the disclosure, each of the Cell-DRX and/or Cell-DTX configurations is provided with at least one parameter that may include but not limited to the following:

Periodicity: Indicates the period of the Cell-DRX and/or Cell-DTX configuration.

Start slot/offset: Indicates the start of the period for Cell-DRX and/or Cell-DTX, an offset value may be indicated when the start slot is to the beginning of the sub-frame.

On duration: A time window within the period for Cell-DRX and/or Cell-DTX configuration, where the cell is receiving and/or transmitting. On duration may be located at the beginning of the period or at an offset to the beginning of the period for Cell-DRX and/or Cell-DTX configuration.

List of cells: Indicates the cells to which one or more of the Cell-DRX and/or Cell-DTX configurations are applicable. Alternatively, for each Cell-DRX and/or Cell-DTX configuration, one or more cells are indicated for which the configuration is applicable. To optimize the signalling, a mapping approach can be used to firstly list the cells (or carriers of the carrier aggregation) and use the index of the cell/carrier or bitmap to map to the cells/carriers for each Cell-DRX and/or Cell-DTX configuration. In an alternate approach, each of the serving cell is identified by a unique cell identity ServCellIndex.

Modes of DTX/DRX/NES Cell: Indicates the mode of Cell-DRX and/or Cell-DTX configuration or NES cell wherein the different modes indicate the different level of receptions and transmissions are turned off by the NES cell. Mode can be assigned an index.

In an embodiment of the disclosure, the NES configuration is provided for the one or more serving cell(s) and for each serving cell. The at least one Cell-DRX and/Cell-DTX configurations are included in the NES configuration for the serving cell. The NES configuration for the serving cell(s) is conveyed by an RRC signalling message (e.g., RRC reconfiguration message or the like).

In an embodiment of the disclosure, the NES configuration is updated and conveyed to the UE 100 when at least one of SCell addition/activation, SCell removal/deactivation, SPCell addition, SCG activation and SCG deactivation takes place. Accordingly, the UE 100 updates the monitoring for the activation/deactivation indication for the Cell-DRX and/or Cell-DTX configurations for the relevant serving cells (e.g., latest aggregated serving cells) through a DCI and/or medium access control control-element (MAC CE).

In an embodiment of the disclosure, at least one of the serving cells can be associated or configured with at least one of the Cell-DRX and/or Cell-DTX configuration. The Cell-DRX and/or Cell-DTX configuration can be identified with an index, e.g., by the order of the Cell-DRX and/or Cell-DTX configuration for the serving cell in the RRC signalling message.

In an embodiment of the disclosure, the network entity 200 signals the Cell DRX and/or Cell DTX configurations to use in an RRC IDLE/INACTIVE state as part of RRCRelease message. The network entity 200 configures the UE 100 with Cell-DTX and/or Cell DRX configurations for at least one of the current serving cell and neighbour cells.

In an embodiment of the disclosure, the UE 100 stores the Cell-DRX and/or Cell-DTX configuration provided as part of dedicated RRC signalling, when transitioning from an RRC CONNECTED state to an RRC IDLE/RRC INACTIVE state.

In an embodiment of the disclosure, the UE 100 releases all the stored cell DRX and/or Cell DTX configuration while reselecting to different cell.

In an embodiment of the disclosure, for each Cell-DRX and/or Cell-DTX configuration that is activated, the Active Time includes the duration during which the on-duration is applicable (or an on-duration timer is running) of the respective Cell-DRX and/or Cell-DTX configuration. During the active time of the Cell-DRX and/or Cell-DTX configuration, the UE 100 remains awake for the NES cell to receive and/or transmit to the NES cell, respectively.

In an embodiment of the disclosure, for each Cell-DRX and/or Cell-DTX configuration that is activated, a non-active time includes the duration during which the on-duration is not applicable (or an on-duration timer is not running) of the respective Cell-DRX and/or Cell-DTX configuration. Alternatively, the non-active time of the Cell-DRX and/or Cell-DTX configuration includes the duration which is not the active time of the Cell-DRX and/or Cell-DTX configuration.

In an embodiment of the disclosure, the network entity 200 activates or deactivates the one or more Cell-DRX and/or Cell-DTX configuration that have been configured to the UE 100. The activation and/or deactivation is signalled by at least one of RRC signalling or layer 1 (L1)/L2 signalling (e.g., downlink control indication, DCI) or medium access control (MAC) signalling (e.g., MAC control element (CE)). For activation and/deactivation of the Cell-DRX and/or Cell-DTX configurations, pertinent indices of the configuration may be used. In another embodiment of the disclosure, a bitmap may be provided for the activation and/or deactivation in the DCI and/or MAC CE where in each bit of the bitmap maps to a specific Cell-DRX and/or Cell-DTX configuration.

In an embodiment of the disclosure, a common DCI or a group common DCI is utilized by the network entity 200 for activation and/deactivation of the configuration of the Cell-DRX and/or Cell-DTX. Therefore, all UEs 100 or a group of UEs 100 can commonly receive the activation and/deactivation signalling.

In an embodiment of the disclosure, a dedicated DCI is utilized by the network entity 200 for activation and/deactivation of the configuration of the Cell-DRX and/or Cell-DTX. Therefore, a specific UE 100 receives the activation and/deactivation signalling.

In an embodiment of the disclosure, only one Cell-DRX and/or Cell-DTX configuration among the configured Cell-DRX and/or Cell-DTX configurations for the UE 100 is activated at a time for a given serving cell and all other configurations are considered as deactivated. With the DCI (e.g., DCI X) and/or the MAC signalling, the network entity 200 may switch the activated Cell-DRX and/or Cell-DTX configuration to another Cell-DRX and/or Cell-DTX configuration which was deactivated.

In an embodiment of the disclosure, only one of the configurations among all Cell-DRX and/or Cell-DTX configurations is activated commonly for all the UEs 100 in the cell and for the NES cell.

In an embodiment of the disclosure, a given Cell-DRX and/or Cell-DTX configuration may be activated at a time for one or more serving cells. In another embodiment of the disclosure, different Cell-DRX and/or Cell-DTX configuration may be activated at a time for different serving cells. It may be conditioned that for the serving cell only one Cell-DRX and/or Cell-DTX configuration is activated at a time.

In an embodiment of the disclosure, one of the configurations among all Cell-DRX and/or Cell-DTX configurations is indicated as activated at the time of the configuration of the Cell-DRX and/or Cell-DTX configuration in the RRC signalling.

In an embodiment of the disclosure, all the Cell-DRX and/or Cell-DTX configurations at the time of the configuration of the Cell-DRX and/or Cell-DTX configuration in the RRC signalling are by default considered as deactivated until one of the configurations are indicated as activated in the DCI and/or MAC signalling.

In an embodiment of the disclosure, the activation and/or deactivation indication for the Cell-DRX and/or Cell-DTX configuration for one or more serving cells received in the DCI and/or MAC CE is applied at a time offset termed as “activation time” and/or “deactivation time” after the reception of the DCI and/or MAC CE. The “activation time” and/or “deactivation time” are pre-configured or pre-specified and can range from 0 (e.g., applicable from the same slot) to N (e.g., applicable from Nth slot after the reception of DCI and/or MAC CE). The pre-configuration can be provided in the RRC signalling and the pre-specified value can be defined in the third generation partnership project (3GPP) specifications.

In an embodiment of the disclosure, the Cell-DRX and/or Cell-DTX configuration activation/deactivation signalling is provided with a common or a group-common DCI (termed as DCI format X or DCI X). One pertinent issue could be that the occasion of DCI X may not coincide with the DRX active time of the specific UE 100 or group of specific UEs 100. To address this, the network entity 200 transmits the DCI X at a pre-configured occasion (i.e., a pre-configured offset to the DRX cycle e.g., with respect to DRX on-duration start) for the specific UE or group of specific UEs 100. The specific UE 100 or the group of specific UEs 100 are dedicatedly configured for the pre-configured occasion of the DCI X. The pre-configured occasion may be one of post on-duration start by the offset (e.g., within DRX on-duration period) or ahead of on-duration start by an offset. In an alternative embodiment of the disclosure, the DCI X is transmitted at a periodic and pre-configured or pre-specified occasions and the UE 100 which is configured with Cell-DRX and/or Cell-DTX configuration receives the DCI X irrespective of the UE's DRX Active Time or not.

In an embodiment of the disclosure, a DCI X is addressed to a new RNTI (termed as NES-RNTI). Further, the group common PDCCH carrying the DCI X is scrambled with the NES-RNTI.

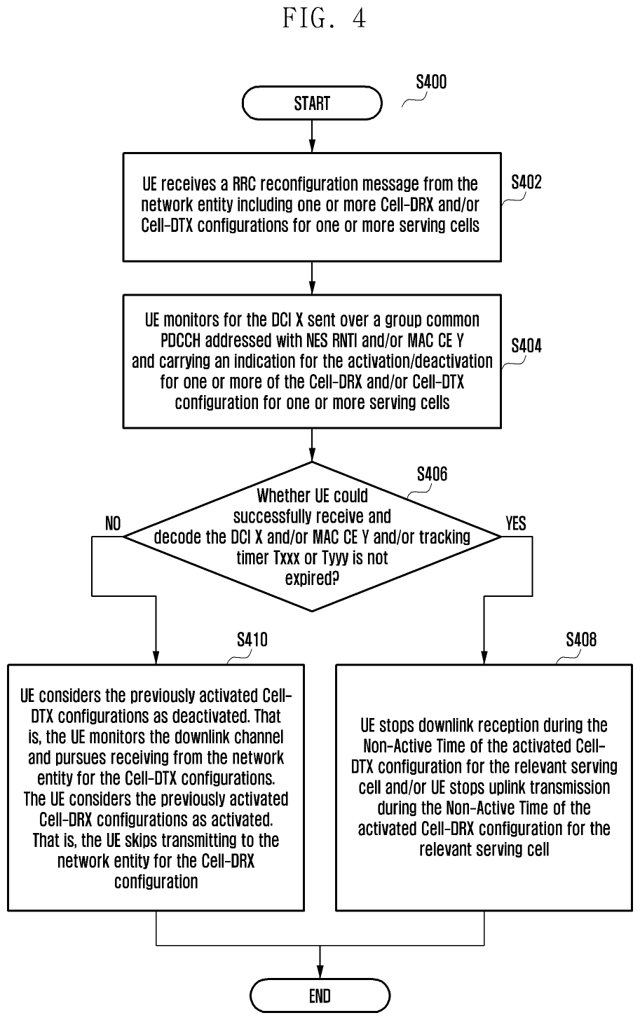

In an embodiment of the disclosure, when the UE 100 fails to receive or decode the DCI X, e.g., channel conditions degrades or the UE 100 is engaged in the MUSIM operation or the UE 100 goes out of coverage, the UE 100 continues to follow the previous Cell-DRX and/or Cell-DTX configuration until it receives/decodes the DCI X again. The DCI X reception failure can be determined when the UE 100 fails to receive for a periodic transmission for the DCI X or when the UE 100 does not receive the DCI X and a tracking timer Txxx expires. The Timer Txxx can be started or restarted when the UE 100 receives the DCI X with activation for the relevant Cell-DRX and/or the Cell-DTX configuration. The timer Txxx can be stopped when the UE 100 receives the DCI X with deactivation for a relevant Cell-DRX and/or Cell-DTX configuration. This is illustrated in FIG. 4, which illustrates a flowchart of a method for receiving and applying the Cell-DRX and/or Cell-DTX configurations for the one or more serving cells.

In an embodiment of the disclosure, when the Timer Txxx expires, the UE 100 considers the previously activated Cell-DTX configurations as deactivated. For example, the UE 100 monitors the downlink channel and pursues receiving from the network entity 200 for the Cell-DTX configurations.

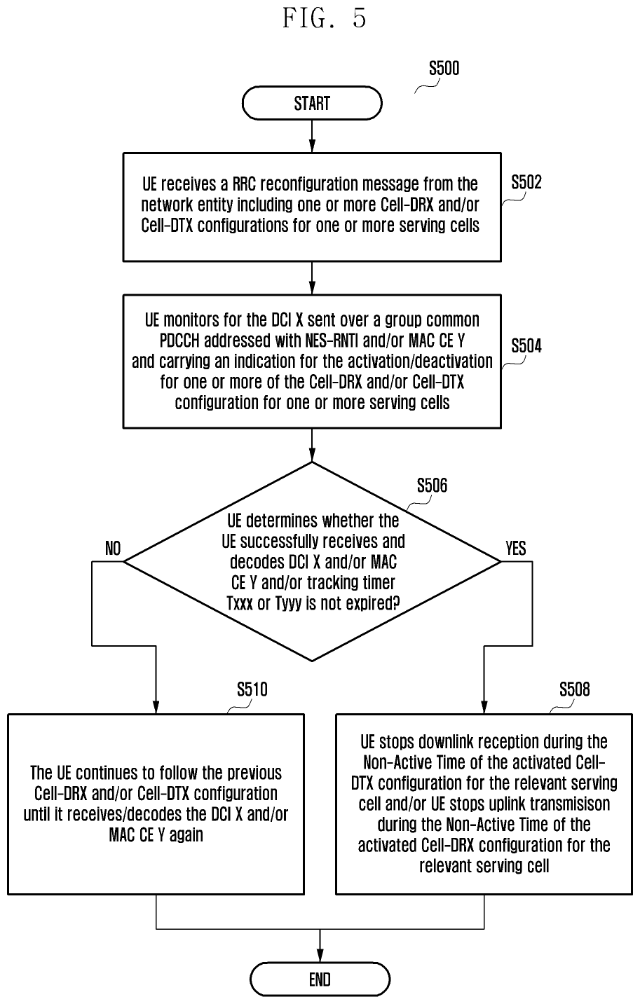

In an embodiment of the disclosure, when the timer Txxx expires, the UE 100 considers the previously activated Cell-DRX configurations as activated. For example, the UE 100 skips transmitting to the network entity 200 for the Cell-DRX configurations. This is illustrated in FIG. 5, which illustrates a flowchart of a method for receiving and applying the Cell-DRX and/or Cell-DTX configurations for the one or more serving cells.

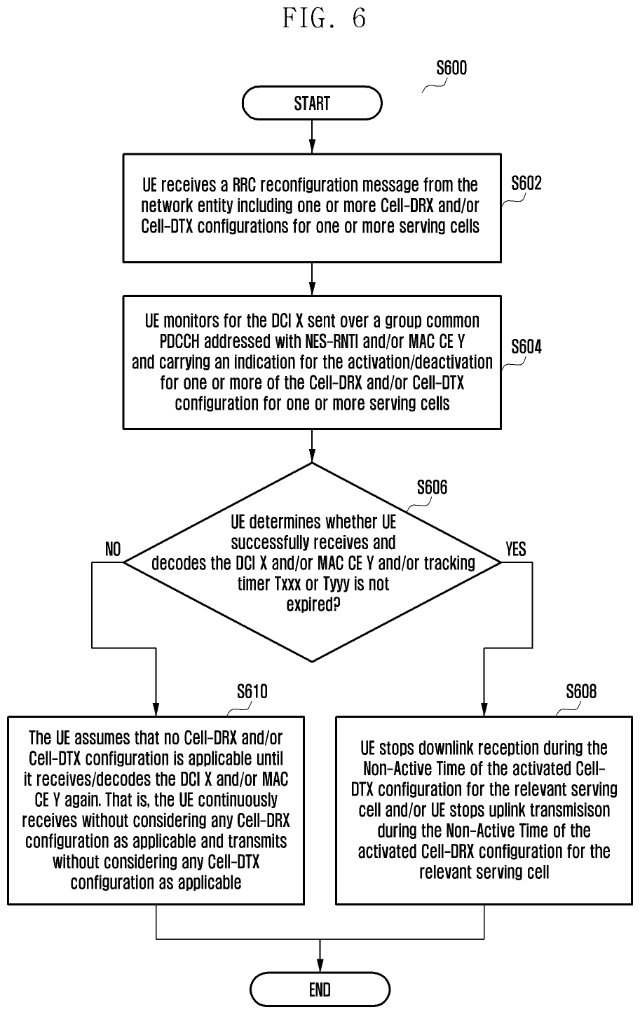

In an embodiment of the disclosure, when the UE 100 fails to receive or decode the DCI X, the UE 100 assumes no Cell-DRX and/or Cell-DTX configuration is applicable until it receives/decodes the DCI X again. For example, the UE 100 continuously receives without considering any Cell-DRX configuration as applicable and transmits without considering any Cell-DTX configuration as applicable. This is illustrated in FIG. 6, which illustrates a flowchart of a method for receiving and applying the Cell-DRX and/or Cell-DTX configurations for one or more serving cells.

In an embodiment of the disclosure, when the UE 100 fails to receive or decode the DCI X, the UE 100 pursues to receive the MAC CE for availing and applying the Cell-DRX and/or Cell-DTX configuration for one or more serving cells.

In an embodiment of the disclosure, when the UE 100 fails to receive or decode the DCI X, the UE 100 responds or feedbacks to the network entity 200 by sending a hybrid automatic repeat request (HARQ)-negative acknowledgment (NACK) for the DCI X reception. The network entity 200 may retransmit the DCI X to enable the UE 100 for receiving the DCI X successfully.

In an embodiment of the disclosure, when the UE 100 succeeds to receive or decode the DCI X, the UE 100 responds or feedbacks to the network entity 200 by sending a HARQ-acknowledgment (ACK) for the DCI X reception.

In an embodiment of the disclosure, in order to enhance the reliability of the DCI X reception, the DCI X may be transmitted more than once (i.e., repetition) and/or DCI X may be retransmitted more than once.

In an embodiment of the disclosure, the UE 100 may monitor and receive the DCI X transmission and/or retransmission irrespective of the Non-Active Time of the activated Cell-DTX configuration, if any, of the serving cell.

In an embodiment of the disclosure, the network entity 200 may transmit and/or retransmit the DCI X irrespective of the non-active time of the activated Cell-DTX configuration, if any, of the serving cell.

In an embodiment of the disclosure, the UE 100 determines the false alarm detection and/or mis-detection of the DCI X and pursues one of the earlier discussed approaches.

Another relevant issue could be that the DCI X needs to signal one or more cell identity pertaining to the Cell-DRX and/or Cell-DTX configuration activation/deactivation. However, different UEs may have different serving cells configured (e.g., cells aggregated for the carrier aggregation for the UE 100). Signalling explicit serving cell identity is however not efficient. In an embodiment of the disclosure, the DCI X is designed to carry a common indexing to the serving cells of all the UEs 100 and thereby resolve any potential confusion with the dedicated configuration of the serving cell for the specific UEs 100. In an embodiment of the disclosure, the DCI X carries the at least one bit or bitmap or code-point or field that corresponds activation/or deactivation indication to the ServCellIndex of the at least one of the aggregated serving cells for the UE(s) 100. The ServCellIndex is included in the dedicated configuration for the UE 100 for the aggregated cell(s) of the UE 100 through an RRC signalling message (for example). The ServCellIndex uniquely identifies each of the serving cells configured for the UE 100. In an embodiment of the disclosure, activation (or deactivation) indication can be signalled by setting the at least one bit or bitmap or code-point or field in the DCI X e.g., to value 1 or TRUE. In an alternate embodiment of the disclosure, the activation (or deactivation) indication can be signalled by resetting the at least one bit or bitmap or code-point or field in the DCI X e.g., to value 0 or FALSE.

In an embodiment of the disclosure, the DCI X carries the at least one bit or bitmap that corresponds to the at least one Cell-DRX and/or Cell-DTX configuration. At least one Cell-DRX and/or Cell-DTX configuration is included in the dedicated configuration for the UE 100 through the RRC signalling message (for example). Further, the at least one Cell-DRX and/or Cell-DTX configuration may relate to the ServCellIndex of the at least one of the aggregated serving cells for the UE(s) 100. In an embodiment of the disclosure, the DCI X carries the at least one bit or bitmap or code-point or field that corresponds activation/or deactivation indication to the at least one of the Cell-DRX and/or Cell-DTX configuration for the UE(s) 100. In an embodiment of the disclosure, the activation (or deactivation) indication can be signalled by setting the at least one bit or the bitmap or the code-point or field in the DCI X e.g., to value 1 or TRUE. In an alternate embodiment of the disclosure, the activation (or deactivation) indication can be signalled by resetting the at least one bit or the bitmap or the code-point or field in the DCI CE e.g., to value 0 or FALSE.

In an embodiment of the disclosure, an example of the RRC configuration signalling for monitoring of the group-common DCI X is provided to receive the activation/deactivation indication for the Cell-DRX and/or Cell-DTX configurations for one or more serving cells of the UE 100 as follows:

### EXAMPLE

| | |
|---|---|
| PDCCH-ServingCellConfig ::= | SEQUENCE { |
| slotFormatIndicator | SetupRelease { SlotFormatIndicator } OPTIONAL, -- |

```
Need M
    ...,
    [[
```

| | |
|---|---|
| availabilityIndicator-r16 | SetupRelease {AvailabilityIndicator-r16} |

OPTIONAL, -- Need M

| | |
|---|---|
| searchSpaceSwitchTimer-r16 | INTEGER (1..80) |

```
OPTIONAL -- Need R
    ]],
    [[
```

| | |
|---|---|
| searchSpaceSwitchTimer-v1710 | INTEGER (81..1280) |

OPTIONAL -- Need R
]]

| | |
|---|---|
| nesActDeactIndicator | SetupRelease {NESActDeactIndicator } |

OPTIONAL -- Need M
}
nesActDeactIndicator: Configuration of NES Activation/Deactivation Indicators to be
monitored in the correspondingly configured PDCCHs of this serving cell.
NESActDeactIndicator ::= SEQUENCE {

| | |
|---|---|
| nes-RNTI | RNTI-Value, |
| dci-PayloadSize | INTEGER (1..maxNES-DCI-PayloadSize), |
| dci-Offset | INTEGER (1...120), |
| dci-OffsetDirection | BOOLEAN |
| periodicity | INTEGER(1...maxNES-DCI-periodicity) |

NESDRXActDeactToAddModList SEQUENCE
(SIZE(1..maxNrofAggregatedCellsPerCellGroup)) OF CellDrx-ActDeactPerCell
NESDRXActDeactToReleaseList SEQUENCE
(SIZE(1..maxNrofAggregatedCellsPerCellGroup)) OF ServCellIndex
NESDTXActDeactToAddModList SEQUENCE
(SIZE(1..maxNrofAggregatedCellsPerCellGroup)) OF CellDtx-ActDeactPerCell
NESDTXActDeactToReleaseList SEQUENCE
(SIZE(1..maxNrofAggregatedCellsPerCellGroup)) OF ServCellIndex
CellDrx-ActDeactPerCell ::= SEQUENCE {

| | |
|---|---|
| servingCellId-r16 | ServCellIndex, |
| positionInDCI-r16 | INTEGER(0..maxNES-DCI-PayloadSize-1) |
| CellDrx-ConfigSet | SEQUENCE (SIZE (1....maxNrofcellDrxConfigPerCell) |

OF CellDrx-Config
}
CellDtx-ActDeactPerCell ::= SEQUENCE {

| | |
|---|---|
| servingCellId-r16 | ServCellIndex, |
| positionInDCI-r16 | INTEGER(0..maxNES-DCI-PayloadSize-1) |
| CellDtx-ConfigSet | SEQUENCE (SIZE (1....maxNrofCellDtxConfigPerCell) |

OF CellDtx-Config
}
Cell-Drx-Config ::= SEQUENCE {
cell-drx-cyclestartSlotOffset CHOICE {

| | |
|---|---|
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| cell-drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, |

ms40, ms50, ms60, ms80, ms100, ms200, ms300, ms400, ms500, ms600, ms800, ms1000,
ms1200, ms1600, spare8, spare7, spare6, spare5, spare4, spare3, spare2, spare1 }

}

}
Cell-Dtx-Config ::= SEQUENCE {
cell-dtx-cyclestartSlotOffset CHOICE {

| | |
|---|---|
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},
cell-dtx-onDurationTimer CHOICE {

subMilliSeconds INTEGER (1..31),
milliSeconds ENUMERATED {
ms1, ms2, ms3, ms4, ms5, ms6, ms8, ms10, ms20, ms30,

ms40, ms50, ms60, ms80, ms100, ms200, ms300, ms400, ms500, ms600, ms800, ms1000,
ms1200, ms1600, spare8, spare7, spare6, spare5, spare4, spare3, spare2, spare1 }

}

}

a) nes-RNTI: RNTI used for NES Activation/Deactivation Indicator (e.g., DCI X) on the given serving cell.

b) dci-PayloadSize: Total length of the DCI payload scrambled with NES-RNTI.

c) dci-Offset: The start of the search-time for DCI X with CRC scrambled with NES-RNTI relative to the start of the drx-onDurationtimer of UE DRX.

d) dci-OffsetDirection: Value 0 indicates offset before the start of the drx-onDurationtimer of UE DRX and value 1 indicates offset after the start of the drx-onDurationtimer of UE DRX.

e) periodicity: Indicates the periodicity of the DCI X occurrence. This may be sub-multiple or integral multiple of UE DRX cycle length or same as UE DRX cycle length.

f) CellDrx-ActDeactPerCell: NES Activation/Deactivation of the Cell-DRX configurations for a serving cell.

g) CellDtx-ActDeactPerCell: NES Activation/Deactivation of the Cell-DTX configurations for a serving cell.

h) positionInDCI: Position in DCI of the bit field indicating NES Activation/Deactivation of the Cell-DRX configurations (or Cell-DTX configurations) for UE's serving cells.

i) servingCellId: The ID of the serving cell for which the configuration is applicable.

j) cell-drx-onDurationTimer: Cell DRX On Duration timer value which indicates the active duration in which the UE 100 can perform transmission to the given serving cell.

k) cell-drx-cycleStartSlotOffset: Indicates the Cell DRX cycle length in ms and the start offset in ms.

l) cell-dtx-onDurationTimer: Cell DTX On Duration timer value which indicates the active duration in which the UE 100 can monitor for downlink reception from the given serving cell.

m) cell-dtx-cycleStartSlotOffset: Indicates the Cell DTX cycle length in ms and the start offset in ms.

In an embodiment of the disclosure, an example of the group-common DCI X is provided to receive the activation/deactivation indication for the Cell-DRX and/or Cell-DTX configurations for the one or more serving cells of the UE 100 as follows:
DCI FORMAT X: DCI format X is used for notifying the activation/deactivation of the Cell-DRX and/or Cell-DTX configurations for the serving cell(s) (for example).

The following information is transmitted by means of the DCI format X with CRC scrambled by NES-RNTI:
If the higher layer parameter NESDRXActDeactToAddModList is configured,
CellDrx ActDeact indicator 1, CellDrx ActDeact indicator 2, . . . , CellDrx ActDeact indicator N,
If the higher layer parameter NESDTXActDeactToAddModList is configured,
CellDtx ActDeact indicator 1, CellDtx ActDeact indicator 2, . . . , CellDtx ActDeact indicator N,
The size of DCI format X is configurable by higher layers up to Z bits.

In an embodiment of the disclosure, the DCI X is monitored in a common search space. The common search space is configured for the DCI X with a set of parameters including at least one of searchspaceld, monitoringSlotPeriodicityandOffset, monitoringSymbolsWithinSlot, duration and so on.

In an embodiment of the disclosure, a DCI X occasion is provided as aligned with the wake-up signal (i.e., DCI format 2_6) so that the UE 100 can receive both DCI X and wakeup signal at same time causing reduced power consumption for the UE 100.

In an embodiment of the disclosure, regardless of the wake-up signal indication for the UE 100 to be awake or sleep in the next DRX cycle, the UE 100 monitors and receives the DCI X at its configured occasion. This is needed to receive at least Cell-DRX configurations for the UE 100 to transmit in the uplink direction properly.

In an embodiment of the disclosure, the NES support status and/or NES configuration for Cell-DRX and/or Cell-DTX for the target cell(s) is provided to the UE 100 in a CHO configuration and/or a handover command message. The UE 100 may accordingly select the target cell and/or configure/control the reception/transmission on the target cell.

In an embodiment of the disclosure, irrespective of whether the PS-Wakeup is configured or not or whether PS-Wakeup field is present or absent, when the DCI format 2_6 is not detected outside active time, the UE 100 monitors and receives the DCI X at its configured occasion. This is needed to receive at least Cell-DRX configurations for the UE 100 to transmit in the uplink direction properly.

In an embodiment of the disclosure, an example of specification is provided which specifies how the UE 100 considers the symbols in the slot or slots for downlink reception and/or uplink transmission in conjunction with the Cell-DRX and/or Cell-DTX configuration(s) for the given serving cell.

In an embodiment of the disclosure, the UE 100 considers symbols in a slot indicated as downlink by tdd-uplink (UL)-downlink (DL)-ConfigurationCommon, or tdd-UL-DL-ConfigurationDedicated to be available for receptions, provided UE 100 is not configured to monitor PDCCH for DCI format X or if the UE 100 is configured to monitor PDCCH for DCI format X, the relevant symbols in the slot are indicated to be within Active Time of the at least one activated Cell-DTX configuration for the serving cell.

The UE 100 considers symbols in the slot indicated as uplink by tdd-UL-DL-ConfigurationCommon, or by tdd-UL-DL-ConfigurationDedicated to be available for transmissions, provided UE 100 is not configured to monitor PDCCH for DCI format X or if the UE 100 is configured to monitor PDCCH for DCI format X, the relevant symbols in the slot are indicated to be within Active Time of the at least one activated Cell-DRX configuration for the serving cell.

If the UE 100 is configured to monitor PDCCH for DCI format X, for a set of symbols of a slot that are indicated as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE 100.

The UE 100 receives physical downlink shared channel (PDSCH) or CSI-RS in the set of symbols of the slot if the UE 100 receives a corresponding indication by the DCI format, provided UE 100 is not configured to monitor PDCCH for DCI format X or if UE 100 is configured to monitor PDCCH for DCI format X, the relevant symbols in the slot are indicated to be within Active Time of the at least one activated Cell-DTX configuration for the serving cell.

The UE 100 transmits physical uplink shared channel (PUSCH), PUCCH, physical random access channel (PRACH), or sounding reference signal (SRS) in the set of symbols of the slot if the UE 100 receives a corresponding indication by a DCI format, a random access response (RAR) UL grant, fallbackRAR UL grant, or successRAR, provided UE 100 is not configured to monitor PDCCH for DCI format X or if the UE 100 is configured to monitor PDCCH for DCI format X, the relevant symbols in the slot are indicated to be within Active Time of the at least one activated Cell-DRX configuration for the serving cell.

For a set of symbols of a slot indicated to the UE 100 as flexible by tdd-UL-DL-ConfigurationCommon and tdd-UL-DL-ConfigurationDedicated if provided, or when tdd-UL-DL-ConfigurationCommon and tdd-UL-DL-ConfigurationDedicated are not provided to the UE 100, and if the UE 100 detects a DCI format 2_0 providing a format for the slot using a slot format value other than 255.

If one or more symbols from the set of symbols are symbols in a control resource set (CORESET) configured to the UE 100 for PDCCH monitoring, the UE 100 receives PDCCH in the CORESET only if an SFI-index field value in DCI format 2_0 indicates that the one or more symbols are downlink symbols, provided UE 100 is not configured to monitor PDCCH for DCI format X or if the UE 100 is configured to monitor PDCCH for DCI format X, the relevant symbols in the slot are indicated to be within Active Time of the at least one activated Cell-DTX configuration for the serving cell.

If an SFI-index field value in DCI format 2_0 indicates the set of symbols of the slot as flexible and the UE 100 detects a DCI format indicating to the UE 100 to receive PDSCH or CSI-RS in the set of symbols of the slot, the UE 100 receives PDSCH or CSI-RS in the set of symbols of the slot, provided UE 100 is not configured to monitor PDCCH for DCI format X or if the UE 100 is configured to monitor PDCCH for DCI format X, the relevant symbols in the slot are indicated to be within Active Time of the at least one activated Cell-DRX configuration for the serving cell.

If an SFI-index field value in DCI format 2_0 indicates the set of symbols of the slot as flexible and the UE 100 detects a DCI format, a RAR UL grant, fallbackRAR UL grant, or successRAR indicating to the UE 100 to transmit PUSCH, PUCCH, PRACH, or SRS in the set of symbols of the slot the UE 100 transmits the PUSCH, PUCCH, PRACH, or SRS in the set of symbols of the slot, provided UE 100 is not configured to monitor PDCCH for DCI format X or if the UE 100 is configured to monitor PDCCH for DCI format X, the relevant symbols in the slot are indicated to be within Active Time of the at least one activated Cell-DRX configuration for the serving cell.

If an SFI-index field value in DCI format 2_0 indicates the set of symbols of the slot as flexible, and the UE 100 does not detect a DCI format indicating to the UE 100 to receive PDSCH or CSI-RS, or the UE 100 does not detect a DCI format, a RAR UL grant, fallbackRAR UL grant, or successRAR indicating to the UE 100 to transmit PUSCH, PUCCH, PRACH, or SRS in the set of symbols of the slot, the UE 100 does not transmit or receive in the set of symbols of the slot.

If the UE 100 is configured by higher layers to receive PDSCH or CSI-RS in the set of symbols of the slot, the UE 100 receives the PDSCH or the CSI-RS in the set of symbols of the slot only if an SFI-index field value in DCI format 2_0 indicates the set of symbols of the slot as downlink and, if applicable, the set of symbols is within remaining channel occupancy duration, provided UE 100 is not configured to monitor PDCCH for DCI format X or if the UE 100 is configured to monitor PDCCH for DCI format X, the relevant symbols in the slot are indicated to be within Active Time of the at least one activated Cell-DTX configuration for the serving cell.

If the UE 100 is configured by higher layers to receive DL PRS in the set of symbols of the slot, the UE 100 receives the DL PRS in the set of symbols of the slot only if an SFI-index field value in DCI format 2_0 indicates the set of symbols of the slot as downlink or flexible, provided UE 100 is not configured to monitor PDCCH for DCI format X or if the UE 100 is configured to monitor PDCCH for DCI format X, the relevant symbols in the slot are indicated to be within Active Time of the at least one activated Cell-DTX configuration for the serving cell.

If the UE 100 is configured by higher layers to transmit PUCCH, or PUSCH, or PRACH in the set of symbols of the slot, the UE 100 transmits the PUCCH, or the PUSCH, or the PRACH in the slot only if an SFI-index field value in DCI format 2_0 indicates the set of symbols of the slot as uplink, provided UE 100 is not configured to monitor PDCCH for DCI format X or if UE 100 is configured to monitor PDCCH for DCI format X, the relevant symbols in the slot are indicated to be within Active Time of the at least one activated Cell-DRX configuration for the serving cell.

If the UE 100 is configured by higher layers to transmit SRS in the set of symbols of the slot, the UE 100 transmits the SRS only in a subset of symbols from the set of symbols of the slot indicated as uplink symbols by an SFI-index field value in DCI format 2_0, provided UE 100 is not configured to monitor PDCCH for DCI format X or if the UE 100 is configured to monitor PDCCH for DCI format X, the relevant symbols in the slot are indicated to be within Active Time of the at least one activated Cell-DRX configuration for the serving cell.

Another relevant issue could be that the NES Activation/Deactivation MAC CE (termed as MAC CE Y) needs to signal one or more cell identity pertaining to the Cell-DRX and/or Cell-DTX configuration activation/deactivation. However, different UEs may have different serving cells configured (e.g., cells aggregated for the carrier aggregation for the UE 100). Signalling explicit serving cell identity is however not efficient. In an embodiment of the disclosure, MAC CE Y is designed to carry a common indexing to the serving cells of all the UEs 100 and thereby resolve any potential confusion with the dedicated configuration of serving cell for specific UEs 100. In an embodiment of the disclosure, MAC CE Y carries the at least one bit or bitmap or code-point or field that corresponds activation and/or deactivation indication to the ServCellIndex of the at least one of the aggregated serving cells for the UE(s) 100. ServCellIndex is included in the dedicated configuration for the UE 100 for the aggregated cell(s) of the UE 100, e.g., through an RRC signalling message. ServCellIndex uniquely identifies each of the serving cells configured for the UE 100. In an embodiment of the disclosure, activation (or deactivation) indication can be signalled by setting the at least one bit or the bitmap or the code-point or field in the MAC CE, e.g., to value 1 or TRUE. In an alternate embodiment of the disclosure, activation (or deactivation) indication can be signalled by resetting the at least one bit or the bitmap or the code-point or the field in the MAC CE Y, e.g., to value 0 or FALSE.

In an embodiment of the disclosure, MAC CE Y carries the at least one bit or bitmap that corresponds to the at least one Cell-DRX and/or Cell-DTX configuration. At least one Cell-DRX and/or Cell-DTX configuration is included in the dedicated configuration for the UE 100 through an RRC signalling message (for example). Further, at least one Cell-DRX and/or Cell-DTX configuration may relate to the ServCellIndex of the at least one of the aggregated serving cells for the UE(s) 100. In an embodiment of the disclosure, MAC CE Y carries the at least one bit or bitmap or code-point or field that corresponds activation/or deactivation indication to the at least one of the Cell-DRX and/or Cell-DTX configuration for the UE(s) 100. In an embodiment of the disclosure, activation (or deactivation) indication can be signalled by setting the at least one bit or the bitmap or the code-point or the field in the MAC CE Y, e.g., to value 1 or TRUE. In an alternate embodiment of the disclosure, activation (or deactivation) indication can be signalled by resetting the at least one bit or the bitmap or the code-point or the field in the MAC CE Y, e.g., to value 0 or FALSE.

In an embodiment of the disclosure, a dedicated MAC CE Y is utilized to carry the activation/deactivation indication for the Cell-DRX and/or Cell-DTX configuration for the UE 100 and the dedicated MAC CE Y carries the at least one bit or bitmap or code-point or field that corresponds activation/or deactivation indication to the at least one of the Cell-DRX and/or Cell-DTX configuration for the UE(s) 100 and is mapped to the respective Cell-DRX and/or Cell-DTX configuration in accordance of the order they are configured to the UE 100 i.e., as per index of the Cell-DRX and/or Cell-DTX configuration in the RRC configuration message.

In an embodiment of the disclosure, in response to receiving MAC CE Y carrying the activation/deactivation indication for one or more Cell-DRX and/or Cell-DTX configuration, the UE 100 responds or feedbacks to the network entity 200 with RESPONSE MAC CE and confirms the successful reception of the MAC CE Y.

In an embodiment of the disclosure, a dedicated MAC CE Y is provided to the UE 100 and is addressed by C-RNTI. The MAC CE Y is mapped to at least one of DCCH or DTCH logical channel.

In an embodiment of the disclosure, a group common MAC CE Y is provided to the UE 100 and is addressed by a pre-specified group common RNTI. The MAC CE Y is mapped to at least one of a group common logical channel, e.g., MBS control channel (MCCH) or MCCH like.

In an embodiment of the disclosure, in response to failure in receiving or decoding MAC protocol data unit (PDU) (carrying MAC CE Y) mapped to a group common logical channel, the UE 100 feedbacks to the network entity 200 with a NACK only HARQ feedback on the PUCCH channel.

In an embodiment of the disclosure, in response to success or failure in receiving or decoding MAC PDU (carrying MAC CE Y) mapped to a group common channel, the UE 100 feedbacks to the network entity 200 with an ACK/NACK HARQ feedback on the PUCCH channel.

In an embodiment of the disclosure, the UE 100 performs one of prioritization or dropping of HARQ feedback (i.e., HARQ NACK or HARQ ACK/NACK) pertaining for DCI X reception and/or MAC CE reception when there is conflict for PUCCH transmission with at least one of dedicated unicast/multicast HARQ feedback, channel state indication (CSI), and scheduling request (SR) over the PUCCH channel.

In an embodiment of the disclosure, an example is shown of the NES activation/deactivation MAC CE (i.e., MAC CE Y) is provided to receive the activation/deactivation indication for the Cell-DRX and/or Cell-DTX configurations for one or more serving cells of the UE 100. In an embodiment of the disclosure, the size of the MAC CE Y may be variable, with the activation/deactivation status for the non-applicable serving cell and/or non-applicable the Cell-DRX configuration and/or Cell-DTX configurations may be skipped. The MAC CE Y is identified by a MAC sub-header with LCID or eLCID as “L”, where L is a pre-specified value. It can be noted many different variations are possible with respect to ordering or arrangement of the elements of the MAC CE Y and all such variations are within the scope of the embodiment of the disclosure.

### EXAMPLE: Nes Activation/Deactivation Mac Ce

| | | | | | | | |
|---|---|---|---|---|---|---|---|
| C7 | C6 | C5 | C4 | C3 | C2 | C1 | Co |
| C15 | C14 | C13 | C12 | C11 | C10 | C9 | C8 |
| C0- | C0- | C0- | C0- | C0- | C0- | C0- | C0- |
| DRX7 | DRX6 | DRX5 | DRX4 | DRX3 | DRX2 | DRX1 | DRXo |
| C0- | C0- | C0- | C0- | C0- | C0- | C0- | C0- |
| DTX7 | DTX6 | DTX5 | DTX4 | DTX3 | DTX2 | DTX1 | DTXo |
| C1- | C1- | C1- | C1- | C1- | C1- | C1- | C1- |
| DRX7 | DRX6 | DRX5 | DRX4 | DRX3 | DRX2 | DRX1 | DRXo |
| C1- | C1- | C1- | C1- | C1- | C1- | C1- | C1- |
| DTX7 | DTX6 | DTX5 | DTX4 | DTX3 | DTX2 | DTX1 | DTXo |
| • | • | • | • | • | • | • | • |
| • | • | • | • | • | • | • | • |

a) Ci: Serving cell C with ServCellIndex i. If Ci is not set (i.e., it is 0), the corresponding Ci-DRXj fields and Ci-DTXj fields are absent. (For example, serving cell Ci is not operated for Cell-DRX and/or Cell-DTX configurations.)

b) Ci-DRXj: If there is a serving cell C configured for the MAC entity with ServCellIndex i, this field indicates the activation/deactivation status of the Cell-DRX configuration j. When Ci-DRXj is set to 1, the respective Cell-DRX configuration j is interpreted as activated. When Ci-DRXj is set to 0, the respective Cell-DRX configuration j is interpreted as deactivated.

c) Ci-DTXj: If there is a serving cell C configured for the MAC entity with ServCellIndex i, this field indicates the activation/deactivation status of the Cell-DTX configuration j. When Ci-DTXj is set to 1, the respective Cell-DRX configuration j is interpreted as activated. When Ci-DTXj is set to 0, the respective Cell-DRX configuration j is interpreted as deactivated.

In an embodiment of the disclosure, there may be reserved fields “R” in the MAC CE Y to allow future extension of the MAC CE Y to cater to a higher number of serving cells and/or a higher number of Cell-DRX and/or Cell-DTX configurations.

In an embodiment of the disclosure, Cell-DRX and/or Cell-DTX configuration activation/deactivation signalling is provided with MAC CE Y over a group-common channel. One pertinent issue could be that the occasion of MAC CE Y may not coincide with the DRX active time of the specific UE 100 or group of specific UEs 100. To address this, the network entity 200 transmits the MAC CE Y at a pre-configured occasion (i.e., a pre-configured offset to the DRX cycle, e.g., with respect to DRX on-duration start) for the specific UE 100 or group of specific UEs 100. The specific UE 100 or group of specific UEs 100 are dedicatedly configured for the pre-configured occasion of the MAC CE Y. The pre-configured occasion may be one of post on-duration start by an offset (e.g., within DRX on-duration period) or ahead of on-duration start by an offset. In an alternative embodiment of the disclosure, MAC CE Y is transmitted at a periodic and pre-configured or pre-specified occasions and the UE 100 which is configured with Cell-DRX and/or Cell-DTX configuration receives the MAC CE Y irrespective of the UE's DRX Active Time or not.

In an embodiment of the disclosure, a MAC CE Y is addressed to a new RNTI (termed as NES-RNTI). Further, the group common channel carrying the MAC CE Y is scrambled with the NES-RNTI.

In an embodiment of the disclosure, when the UE 100 fails to receive or decode the MAC CE Y, e.g., channel conditions degrades or the UE 100 is engaged in MUSIM operation or the UE 100 goes out of coverage, the UE 100 continues to follow the previous Cell-DRX and/or Cell-DTX configuration until it receives/decodes the MAC CE Y again. The MAC CE Y reception failure can be determined when the UE 100 fails to receive for a periodic transmission for MAC CE Y or when the UE 100 does not receive a MAC CE Y and a tracking timer Tyyy expires. Timer Tyyy can be started or restarted when the UE 100 receives MAC CE Y with activation for a relevant Cell-DRX and/or Cell-DTX configuration. Timer Tyyy can be stopped when the UE 100 receives MAC CE Y with deactivation for a relevant Cell-DRX and/or Cell-DTX configuration.

In an embodiment of the disclosure, when Timer Tyyy expires, the UE 100 considers the previously activated Cell-DTX configurations as deactivated. For example, the UE 100 monitors the downlink channel and pursues receiving from the network entity 200 for the Cell-DTX configurations.

In an embodiment of the disclosure, when Timer Tyyy expires, the UE 100 considers the previously activated Cell-DRX configurations as activated. For example, the UE 100 skips transmitting to the network entity 200 for the Cell-DRX configurations.

In an embodiment of the disclosure, in order to enhance the reliability of the MAC CE Y reception, the MAC CE Y may be transmitted more than once (i.e., repetition) and/or MAC CE Y may be retransmitted more than once.

In an embodiment of the disclosure, the UE 100 may monitor for and receive MAC CE Y transmission and/or retransmission irrespective of the Non-Active Time of the activated Cell-DTX configuration, if any, of the serving cell.

In an embodiment of the disclosure, the network entity 200 may transmit and/or retransmit the MAC PDU carrying the MAC CE Y irrespective of the Non-Active Time of the activated Cell-DTX configuration, if any, of the serving cell.

In an embodiment of the disclosure, the UE 100 sends a UE capability message to inform the network entity 200 about the UE capability or support for at least one of the NES feature, Cell-DRX, Cell-DTX, maximum number of configurations, maximum number of active configurations, maximum number of cells for NES support, support for DCI X and/or MAC CE Y, range for activation time, range for deactivation time.

In an embodiment of the disclosure, the network entity 200 configures the UE 100 for NES configurations through an RRC signalling message (e.g., an RRC Reconfiguration message. The NES configuration comprises the configuration(s) for Cell-DRX and/or configuration(s) for Cell-DTX for one or more serving cells; i.e., multiple configurations can be provided for the Cell-DRX and/or Cell-DTX to the UE 100. Each of the Cell-DRX and/or Cell-DTX configurations can be explicitly assigned an index or implicitly mapped to an index; e.g., in the order of the Cell-DRX and/or Cell-DTX configurations present in the RRC reconfiguration. Each of the Cell-DRX and/or Cell-DTX configurations is applicable for at least one serving cell or a specific serving cell.

In an embodiment of the disclosure, for each Cell-DRX and/or Cell-DTX configuration that is activated, the Active Time comprises the duration during which the on-duration is applicable (or an on-duration timer is running) of the respective Cell-DRX and/or Cell-DTX configuration. During the Active time of the Cell-DRX and/or Cell-DTX configuration, the UE 100 may transmit to the NES cell and/or receive from the NES cell respectively.

In an embodiment of the disclosure, the network entity 200 activates or deactivates one or more Cell-DRX and/or Cell-DTX configuration that have been configured to the UE 100. The activation and/or deactivation is signalled by at least one of RRC signalling or downlink control indication (DCI, e.g., termed as DCI X) signalling in the physical control channel (PDCCH), or medium access control (MAC) signalling (e.g., MAC control element (CE), say, termed as MAC CE Y). For activation and/deactivation of the Cell-DRX and/or Cell-DTX configurations in the DCI X and/or MAC CE Y, one or more relevant indices of the configuration provided in the RRC configuration message may be used. In another embodiment of the disclosure, a bitmap may be provided for the activation and/or deactivation in the DCI X and/or MAC CE Y, wherein each bit of the bitmap maps to a specific Cell-DRX and/or Cell-DTX configuration. For activation and/deactivation of the Cell-DRX and/or Cell-DTX configurations for the serving cell(s) in the DCI X and/or MAC CE Y, pertinent indices of the serving cells provided in the RRC configuration message may be used. In another embodiment of the disclosure, a bitmap may be provided for the serving cell(s) in the DCI X and/or MAC CE Y where in each bit of the bitmap maps to a specific serving cell for which the activation/deactivation of the Cell-DRX and/or Cell-DTX configuration is provided.

In an embodiment of the disclosure, the common DCI or the group common DCI X is utilized by the network entity 200 for activation and/deactivation of the configuration of the Cell-DRX and/or Cell-DTX for one or more serving cell(s). Therefore, all UEs 100 or the group of UEs 100 can commonly receive the activation and/deactivation signalling.

In an embodiment of the disclosure, the RRC signalling and/or DCI X and/or MAC CE Y carrying the activation/deactivation indication for the Cell-DRX and/or Cell-DTX configuration(s) for one or more serving cell(s) (i.e., NES cell(s)) may be provided on a primary cell. In another embodiment of the disclosure, the DCI X and/or MAC CE Y may be provided on one of the NES cell(s) in the aggregated cells of the UE 100. In another embodiment of the disclosure, the DCI X and/or MAC CE Y may be provided on each of the NES cell(s) in the aggregated cells of the UE 100 and carries activation/deactivation indication for the Cell-DRX and/or Cell-DTX configuration(s) for the respective NES cell.

In an embodiment of the disclosure, the activation and/or deactivation indication for the Cell-DRX and/or Cell-DTX configuration(s) for one or more serving cells received in the DCI X and/or MAC CE Y is applied at the next Cell-DRX and/or Cell-DTX cycle for the relevant the Cell-DRX and/or Cell-DTX configuration(s) for one or more serving cells after the reception of the DCI X and/or MAC CE Y. In an embodiment of the disclosure, the activation and/or deactivation indication for the Cell-DRX and/or Cell-DTX configuration for one or more serving cells received in the DCI X and/or MAC CE Y is applied at the Nth Cell-DRX and/or Cell-DTX cycle of the relevant Cell-DRX and/or Cell-DTX configuration(s) for one or more serving cells after the reception of the DCI X and/or MAC CE Y. The pre-configuration can be provided in the RRC signalling and the pre-specified value can be defined in the 3GPP specifications.

In an embodiment of the disclosure, the activation and/or deactivation indication for the Cell-DRX and/or Cell-DTX configuration(s) for one or more serving cells received in the DCI X and/or MAC CE Y is applied at a time offset termed as “activation time” and/or “deactivation time” after the reception of the DCI and/or MAC CE. The “activation time” and/or “deactivation time” are pre-configured or pre-specified and can range from 0 (e.g., applicable from the same slot) to N (e.g., applicable from Nth slot after the reception of DCI X and/or MAC CE Y). The “activation time” and/or “deactivation time” are measured after the completion of the reception of the activation and/or deactivation indication on the physical channel e.g., after the end of PDCCH reception for DCI X. The pre-configuration can be provided in the RRC signalling and/or the pre-specified value can be defined in the 3GPP specifications.

In an embodiment of the disclosure, the “activation time” and/or “deactivation time” for the activation and/or deactivation indication received in the DCI X and/or MAC CE Y is commonly applied for more than one and/or all Cell-DRX and/or Cell-DTX configuration(s) for one or more serving cells.

In an embodiment of the disclosure, at least one parameter of the Cell-DRX and/or Cell-DTX configurations can be aligned. The parameter may include at least one of the cycle length, periodicity, on-duration of the Cell-DRX and/or Cell-DTX configurations.

In an embodiment of the disclosure, when the UE 100 fails to receive or decode the DCI X, at least one configured RRC parameter (e.g., PrevDrxDtxDCIxFail) to the UE 100 indicates whether the UE 100 continues to follow the previous Cell-DRX and/or Cell-DTX configuration(s) until it receives/decodes the DCI X again. The DCI X reception failure can be determined when the UE 100 fails to receive for a periodic transmission for DCI X or when the UE 100 does not receive a DCI X and a tracking timer Txxx expires. The at least one tracking timer Txxx is configured to the UE 100 in the RRC signalling (e.g., RRC Reconfiguration message) for one or more serving cell(s).

In an embodiment of the disclosure, when the UE 100 fails to receive or decode the DCI X, at least one configured RRC parameter (e.g., DtxActDeactDCIxFail) to the UE 100 indicates whether the UE 100 considers the previously activated Cell-DTX configurations as deactivated (or activated). For example, when considering Cell-DTX configurations as deactivated, the UE 100 continues to monitor the downlink channel and pursues receiving from the network entity 200 regardless of the Cell-DTX configurations. When considering Cell-DTX configurations as activated, the UE 100 continues to monitor the downlink channel and pursues receiving from the network entity 200 in the Active time of the Cell-DTX configurations.

In an embodiment of the disclosure, when the UE 100 fails to receive or decode the DCI X, at least one configured RRC parameter (e.g., DrxActDeactDCIxFail) to the UE 100 indicates whether the UE 100 considers the previously activated Cell-DRX configurations as activated (or deactivated). For example, when considering Cell-DRX configurations as activated, the UE 100 skips transmitting to the network entity 200 for the non-Active Time of the Cell-DRX configurations. When considering Cell-DRX configurations as deactivated, the UE 100 may transmit to the network entity 200 regardless of the Cell-DRX configurations.

In an embodiment of the disclosure, when the UE 100 fails to receive or decode the DCI X, at least one configured RRC parameter (e.g., NoDrxDtxDCIxFail) to the UE 100 indicates whether the UE 100 considers no Cell-DRX and/or Cell-DTX configuration is applicable until it receives/decodes the DCI X again, i.e., the UE 100 continuously receives without considering any Cell-DRX configuration as applicable and transmits without considering any Cell-DTX configuration as applicable.

In an embodiment of the disclosure, when the UE 100 fails to receive or decode the DCI X, the UE 100 pursues to receive the MAC CE Y for availing and applying the Cell-DRX and/or Cell-DTX configuration for one or more serving cells.

In an embodiment of the disclosure, when the UE 100 fails to receive or decode the DCI X, at least one configured RRC parameter (e.g., MACCEEnablerDCIx) to the UE 100 indicates whether the UE 100 pursues to receive the MAC CE Y for availing and applying the Cell-DRX and/or Cell-DTX configuration for one or more serving cells.

In an embodiment of the disclosure, when the UE 100 fails to receive or decode the DCI X, at least one configured RRC parameter (e.g., MACCEReqEnablerDCIx) to the UE 100 indicates whether the UE 100 sends a MAC CE for NES activation/deactivation request and may receive a MAC CE for NES activation/deactivation response from the network entity 200 carrying the activation and/or deactivation of the Cell-DRX and/or Cell-DTX configurations for one or more serving cells.

In an embodiment of the disclosure, when the UE 100 fails to receive or decode the DCI X, the UE 100 sends a MAC CE for NES activation/deactivation request and may receive a MAC CE for NES activation/deactivation response from the network entity 200 carrying the activation and/or deactivation of the Cell-DRX and/or Cell-DTX configurations for one or more serving cells.

In an embodiment of the disclosure, the UE 100 is configured with at least one configured RRC parameter (e.g., HARQNackEnablerDCIx) that indicates whether when the UE 100 fails to receive or decode the DCI X, the UE 100 responds or feedbacks to the network entity 200 by sending a HARQ-NACK for the DCI X reception. The network entity 200 may retransmit the DCI X to enable UE 100 for receiving the DCI X successfully.

In an embodiment of the disclosure, the UE 100 is configured with at least one configured RRC parameter (e.g., HARQNackEnablerDCIx) that indicates whether when the UE 100 fails to receive or decode the DCI X, the UE 100 responds or feedbacks to the network entity 200 by sending a HARQ-NACK for the DCI X reception. The network entity 200 may transmit the MAC CE Y to the UE 100 to enable the UE 100 for receiving activation/deactivation for Cell-DRX and/or Cell-DTX configurations.

In an embodiment of the disclosure, when the UE 100 fails to receive or decode the DCI X, the UE 100 responds or feedbacks to the network entity 200 by sending a HARQ-NACK for the DCI X reception. The network entity 200 may transmit the MAC CE Y to the UE 100 to enable the UE 100 for receiving activation/deactivation for Cell-DRX and/or Cell-DTX configurations.

In an embodiment of the disclosure, the UE 100 is configured with at least one configured RRC parameter (e.g., HARQAckEnablerDCIx) that indicates whether when the UE 100 succeeds to receive or decode the DCI X, the UE 100 responds or feedbacks to the network entity 200 by sending a HARQ-ACK for the DCI X reception.

In an embodiment of the disclosure, the network entity 200 pursues the transmission of the MAC CE Y to the UE(s) 100 which is poor channel conditions e.g., network entity 200 may check the measurement for the UE's serving cell(s) and if that is below a threshold level (e.g., a level of RSRP or RSRQ or SINR), the network entity 200 perform the transmission of the MAC CE Y to the UE(s) 100. In another embodiment of the disclosure, the threshold level may be configured to the UE 100 in the RRC signalling or is specified so that UE 100 can be aware about to pursue reception of the MAC CE Y when the DCI X decode or reception is failed or when DCI X is not provided.

In an embodiment of the disclosure, the UE 100 is configured with at least one configured RRC parameter (e.g., numRepetitions) that indicates the number of repetitions for the DCI X is allowed in order to enhance the reliability or retransmission of the DCI X reception.

In an embodiment of the disclosure, the DCI X carries the at least one bit or bitmap or code-point or field that corresponds activation/or deactivation indication to the ServCellIndex of the at least one of the aggregated serving cells for the UE(s) 100. ServCellIndex is included in the dedicated configuration for the UE 100 for the aggregated cell(s) of the UE 100 through the RRC signalling message (for example). The ServCellIndex uniquely identifies each of the serving cells configured for the UE 100. In an embodiment of the disclosure, the activation (or deactivation) indication can be signalled by setting the at least one bit or bitmap or code-point or field in the DCI X e.g., to value 1 or TRUE. In an alternate embodiment of the disclosure, the activation (or deactivation) indication can be signalled by resetting the at least one bit or bitmap or code-point or field in the DCI X e.g., to value 0 or FALSE.

In an embodiment of the disclosure, the DCI X carries the at least one bit or bitmap that corresponds to the at least one Cell-DRX and/or Cell-DTX configuration. At least one Cell-DRX and/or Cell-DTX configuration is included in the dedicated configuration for the UE 100 through the RRC signalling message (for example). Further, at least one Cell-DRX and/or Cell-DTX configuration may relate to the ServCellIndex of the at least one of the aggregated serving cells for the UE(s) 100. In an embodiment of the disclosure, the DCI X carries the at least one bit or bitmap or code-point or field that corresponds activation/or deactivation indication to the at least one of the Cell-DRX and/or Cell-DTX configuration for the UE(s) 100. In an embodiment of the disclosure, activation (or deactivation) indication can be signalled by setting the at least one bit or the bitmap or the code-point or the field in the DCI X e.g., to value 1 or TRUE. In an alternate embodiment of the disclosure, activation (or deactivation) indication can be signalled by resetting the at least one bit or the bitmap or the code-point or the field in the DCI CE e.g., to value 0 or FALSE.

In an embodiment of the disclosure, DCI X comprises of one or more blocks to carry the activation/deactivation for Cell-DRX and/or Cell-DTX configurations for one or more serving cell(s). The blocks may be numbered sequentially. Further, the Cell-DRX and/or Cell-DTX configurations for a group of UEs 100 may be mapped to one of the blocks. For example, there is a mapping between UE groups and blocks in the DCI X.

In an embodiment of the disclosure, a dedicated MAC CE Y is provided to the UE 100 and is addressed by C-RNTI. The MAC CE Y is mapped to at least one of DCCH or DTCH logical channel. In an embodiment of the disclosure, in the dedicated MAC CE Y, only the activation/deactivation for the Cell-DRX and/Cell-DTX configuration(s) for one or more serving cell(s), which are relevant to the concerned UE 100 is provided. In an embodiment of the disclosure, in the dedicated MAC CE Y, all the activation/deactivation for the Cell-DRX and/Cell-DTX configuration(s) for one or more serving cell(s), are provided to the concerned UE 100. For example, the same common activation/deactivation indication which is common to all the UEs 100 are provided over the MAC CE and the concerned UE 100 can select and utilize the contents from the MAC CE which is relevant to itself.

In an embodiment of the disclosure, a precedence or a priority for the application of the DCI X or MAC CE Y is configured to the UE 100 in the RRC signalling or is specified (e.g., in 3GPP specification) that implies when the UE 100 receives both DCI X and the MAC CE Y, which one is considered by the UE 100, for applying the activation/deactivation for the Cell-DRX and/or Cell-DTX configurations for one or more serving cell(s).

In an embodiment of the disclosure, the UE 100 applies the MAC CE Y, on the UE 100 receiving both DCI X and the MAC CE Y.

In an embodiment of the disclosure, the UE 100 applies the DCI X, on the UE 100 receiving both DCI X and the MAC CE Y.

In an embodiment of the disclosure, the UE 100 applies the one from DCI X and MAC CE Y which has been received the last by the UE 100 (i.e., latest activation/deactivation indication signalling is applied).

In an embodiment of the disclosure, the MAC CE Y overrides the activation/deactivation indication received in DCI X, on the UE 100 also receiving the MAC CE Y and the MAC CE Y has different activation/deactivation indication as compared to the DCI X.

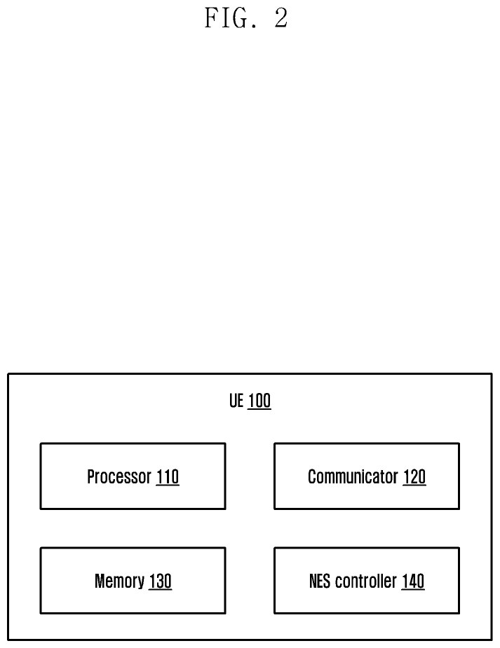

FIG. 2 shows various hardware components of a UE 100, according to an embodiment of the disclosure.

Referring to FIG. 2, in an embodiment of the disclosure, the UE 100 includes a processor 110, a communicator 120, memory 130 and a NES controller 140. The processor 110 is coupled with the communicator 120, the memory 130 and the NES controller 140.

The NES controller 140 receives the RRC reconfiguration message from the network entity 200. The RRC reconfiguration message includes at least one of: the Cell-DRX configuration and the Cell-DTX configuration for the at least one serving cell. Further, the NES controller 140 performs at least one of the activation and deactivation for at least one of the Cell-DRX configuration and the Cell-DTX configuration by at least one of: the RRC reconfiguration message and the DCI termed as DCI X. Further, the NES controller 140 handles the NES in the wireless network 300 upon performing at least one of the activation and deactivation for at least one of the Cell-DRX configuration and the Cell-DTX configuration.

In an embodiment of the disclosure, the bitmap is provided in the DCI X for at least one of the activation and deactivation for at least one of the Cell-DRX configuration and the Cell-DTX configuration. The DCI X is at least one of: the common DCI and the group common DCI. The DCI X can be a DCI format 2_9.

In an embodiment of the disclosure, the at least one of the common DCI and the group common DCI is utilized by the network entity 200 for activation of at least one of: the Cell-DRX configuration and the Cell-DTX configuration and deactivation of at least one of: the Cell-DRX configuration and Cell-DTX configuration.

In an embodiment of the disclosure, each bit of the bitmap maps to at least one of: the Cell-DRX configuration and the Cell-DTX configuration. The bitmap includes a 1 bit or 2 bits for at least one of: the Cell-DRX configuration and Cell-DTX configuration.

In an embodiment of the disclosure, at least one of: the cell-DRX configuration and the cell-DTX configuration is activated at a time for the at least one serving cell.

In an embodiment of the disclosure, different configuration of at least one of: the cell-DRX configuration and the cell-DTX configuration is activated at a time for different serving cells.

In an embodiment of the disclosure, an activation indication and a deactivation indication for at least one of: the cell-DRX configuration and the Cell-DTX configuration for the at least one serving cell received in the DCI X is applied at a time offset as the activation time and the deactivation time after a reception of the DCI X.

In an embodiment of the disclosure, at least one of: the activation time and the deactivation time is pre-specified, wherein the at least one of: the activation time and the deactivation time corresponds to a minimum time gap value after the reception of DCI X, wherein minimum time gap is pre-specified as N slots after the reception of DCI X.

In an embodiment of the disclosure, the specific UEs 100 or the group of UEs 100 commonly receive the activation of signalling and deactivation of signalling. The UE 100 or the group of UEs 100 is dedicatedly configured for a pre-configured occasion of the DCI X. The pre-configured occasion is one of post on-duration start by an offset within the DRX on-duration period or before on-duration start by an offset.

In an embodiment of the disclosure, the DCI X is addressed to the NES-RNTI. The group common PDCCH carrying the DCI X is scrambled with the NES-RNTI.

In an embodiment of the disclosure, the DCI X carries at least one of: the bit, the bitmap, a code-point, and a field that corresponds activation or deactivation indication to the at least one of the cell-DRX and the cell-DTX configuration.

In an embodiment of the disclosure, the configuration of the activation indication and the configuration of the deactivation indication is to be monitored in correspondingly configured PDCCHs of the at least one serving cell.

In an embodiment of the disclosure, position in the DCI X of the bit field that indicates at least one of: activation and deactivation of the at least one of: the Cell-DRX configuration and the Cell-DTX configuration for the at least one serving cell is given by parameter positionInDCI-cellDTRX, wherein a starting position of a block associated with the at least one serving cell is determined by a parameter positionInDCI-cellDTRX provided by a higher layer for the UE 100.

In an embodiment of the disclosure, the size of the DCI X is configurable by the higher layer up to specified bits.

The NES controller 140 is implemented by analog and/or digital circuits, such as logic gates, integrated circuits, microprocessors, microcontrollers, memory circuits, passive electronic components, active electronic components, optical components, hardwired circuits and the like, and may optionally be driven by firmware.

The processor 110 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The processor 110 may include multiple cores and is configured to execute the instructions stored in the memory 130.

Further, the processor 110 is configured to execute instructions stored in the memory 130 and to perform various processes. The communicator 120 is configured for communicating internally between internal hardware components and with external devices via one or more networks. The memory 130 also stores instructions to be executed by the processor 110. The memory 130 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 130 may, in some examples, be considered a non-transitory storage medium. The term “non-transitory” may indicate that the storage medium is not embodied in a carrier wave or a propagated signal. However, the term “non-transitory” should not be interpreted that the memory 130 is non-movable. In certain examples, a non-transitory storage medium may store data that can, over time, change (e.g., in random access memory (RAM) or cache).

Although FIG. 2 shows various hardware components of the UE 100 but it is to be understood that other embodiments are not limited thereon. In other embodiments of the disclosure, the UE 100 may include less or more number of components. Further, the labels or names of the components are used only for illustrative purposes and does not limit the scope of the disclosure. One or more components can be combined together to perform the same or substantially similar function in the UE 100.

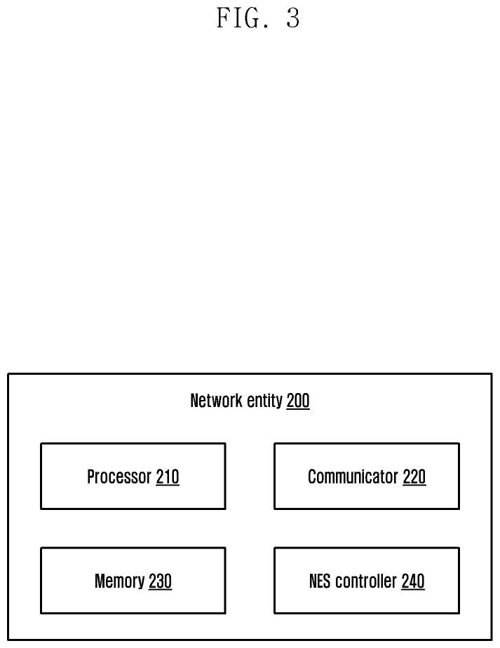

FIG. 3 shows various hardware components of a network entity 200, according to an embodiment of the disclosure.

Referring to FIG. 3, in an embodiment of the disclosure, the network entity 200 includes a processor 210, a communicator 220, memory 230 and a NES controller 240. The processor 210 is coupled with the communicator 220, the memory 230 and the NES controller 240.

The NES controller 240 sends the RRC reconfiguration message to the UE 100. The RRC reconfiguration message includes at least one of: the Cell-DRX configuration and the Cell-DTX configuration for the at least one serving cell. Further, the NES controller 240 performs at least one of the activation and deactivation for at least one of the Cell-DRX configuration and the Cell-DTX configuration by at least one of: the RRC reconfiguration message and a DCI termed as DCI X. Further, the NES controller 240 handles the NES in the wireless network 300 upon performing at least one of the activation and deactivation for at least one of the Cell-DRX configuration and the Cell-DTX configuration.

The NES controller 240 is implemented by analog and/or digital circuits, such as logic gates, integrated circuits, microprocessors, microcontrollers, memory circuits, passive electronic components, active electronic components, optical components, hardwired circuits and the like, and may optionally be driven by firmware.

The processor 210 may include one or a plurality of processors. The one or the plurality of processors may be a general-purpose processor, such as a central processing unit (CPU), an application processor (AP), or the like, a graphics-only processing unit, such as a graphics processing unit (GPU), a visual processing unit (VPU), and/or an AI-dedicated processor, such as a neural processing unit (NPU). The processor 210 may include multiple cores and is configured to execute the instructions stored in the memory 230.

Further, the processor 210 is configured to execute instructions stored in the memory 230 and to perform various processes. The communicator 220 is configured for communicating internally between internal hardware components and with external devices via one or more networks. The memory 230 also stores instructions to be executed by the processor 210. The memory 230 may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 230 may, in some examples, be considered a non-transitory storage medium. The term “non-transitory” may indicate that the storage medium is not embodied in a carrier wave or a propagated signal. However, the term “non-transitory” should not be interpreted that the memory 230 is non-movable. In certain examples, a non-transitory storage medium may store data that can, over time, change (e.g., in random access memory (RAM) or cache).

Although FIG. 3 shows various hardware components of the network entity 200 but it is to be understood that other embodiments are not limited thereon. In other embodiments of the disclosure, the network entity 200 may include less or more number of components. Further, the labels or names of the components are used only for illustrative purposes and does not limit the scope of the disclosure. One or more components can be combined together to perform the same or substantially similar function in the network entity 200.

FIG. 4 is a flowchart S400 illustrating a method for receiving and applying a Cell-DRX and/or Cell-DTX configurations for the one or more serving cells, according to an embodiment of the disclosure.

Referring to FIG. 4, at operation S402, the UE 100 receives the RRC reconfiguration message, from the network entity 200, including the one or more Cell-DRX and/or Cell-DTX configurations for the one or more serving cells. At operation S404, the UE 100 monitors for the DCI X sent over the group common PDCCH addressed with NES-RNTI and/or MAC CE Y and carrying an indication for the activation/deactivation for one or more of the Cell-DRX and/or Cell-DTX configuration for one or more serving cells. At operation S406, the UE 100 determines that the UE 100 successfully receives and decodes the DCI X and/or MAC CE Y and/or tracking timer Txxx or Tyyy is not expired?

In response to the UE 100 determining that the UE 100 successfully receives and decodes the DCI X and/or MAC CE Y and/or tracking timer Txxx or Tyyy is not expired, at operation S408, the UE 100 stops downlink reception during the non-active time of the activated Cell-DTX configuration for the relevant serving cell and/or the UE 100 stops uplink transmission during the non-active time of the activated Cell-DRX configuration for the relevant serving cell.

In response to the UE 100 determining that the UE 100 does not successfully receive and decode the DCI X and/or MAC CE Y and/or tracking timer Txxx or Tyyy is expired then, at operation S410, the UE 100 considers the previously activated Cell-DTX configurations as deactivated. For example, the UE 100 monitors the downlink channel and pursues receiving from the network entity 200 for the Cell-DTX configurations. The UE 100 considers the previously activated Cell-DRX configurations as activated. For example, the UE 100 skips transmitting to the network entity 200 for the Cell-DRX configuration.

FIG. 5 is a flowchart S500 illustrating of a method for receiving and applying a Cell-DRX and/or Cell-DTX configurations for one or more serving cells, according to an embodiment of the disclosure.

Referring to FIG. 5, at operation S502, the UE 100 receives the RRC reconfiguration message, from the network entity 200, including the one or more Cell-DRX and/or Cell-DTX configurations for the one or more serving cells. At operation S504, the UE 100 monitors for the DCI X sent over the group common PDCCH addressed with the NES-RNTI and/or the MAC CE Y and carrying an indication for the activation/deactivation for one or more of the Cell-DRX and/or Cell-DTX configuration for the one or more serving cells. At operation S506, the UE 100 determines whether the UE 100 successfully receives and decodes the DCI X and/or MAC CE Y and/or tracking timer Txxx or Tyyy is not expired?

In response to determining that the UE 100 successfully receives and decodes the DCI X and/or MAC CE Y and/or tracking timer Txxx or Tyyy is not expired, at operation S508, the UE 100 stops downlink reception during the non-active time of the activated Cell-DTX configuration for the relevant serving cell and/or the UE 100 stops uplink transmission during the non-active time of the activated Cell-DRX configuration for the relevant serving cell.

In response to determining that the UE 100 does not successfully receive and decode the DCI X and/or the MAC CE Y and/or tracking timer Txxx or Tyyy is not expired, at operation S510, the UE 100 continues to follow the previous Cell-DRX and/or Cell-DTX configuration until it receives/decodes the DCI X and/or MAC CE Y again.

FIG. 6 is a flowchart S600 illustrating a method for receiving and applying a Cell-DRX and/or Cell-DTX configurations for one or more serving cells, according to an embodiment of the disclosure.

Referring to FIG. 6, at operation S602, the UE 100 receives the RRC reconfiguration message, from the network entity 200, including the one or more Cell-DRX and/or Cell-DTX configurations for the one or more serving cells. At operation S604, the UE 100 monitors for the DCI X sent over the group common PDCCH addressed with the NES-RNTI and/or MAC CE Y and carrying the indication for the activation/deactivation for one or more of the Cell-DRX and/or Cell-DTX configuration for the one or more serving cells.

At operation S606, the UE 100 determines whether the UE 100 successfully receives and decodes the DCI X and/or MAC CE Y and/or tracking timer Txxx or Tyyy is not expired?

In response to determining that the UE 100 successfully receives and decodes the DCI X and/or MAC CE Y and/or tracking timer Txxx or Tyyy is not expired, at operation S608, the UE 100 stops downlink reception during the non-active time of the activated Cell-DTX configuration for the relevant serving cell and/or the UE 100 stops uplink transmission during the non-active time of the activated Cell-DRX configuration for the relevant serving cell.

In response to determining that the UE 100 does not successfully receive and decode the DCI X and/or MAC CE Y and/or tracking timer Txxx or Tyyy is not expired, at operation S610, the UE 100 assumes that no Cell-DRX and/or Cell-DTX configuration is applicable until it receives/decodes the DCI X and/or MAC CE Y again. For example, the UE 100 continuously receives without considering any Cell-DRX configuration as applicable and transmits without considering any Cell-DTX configuration as applicable.

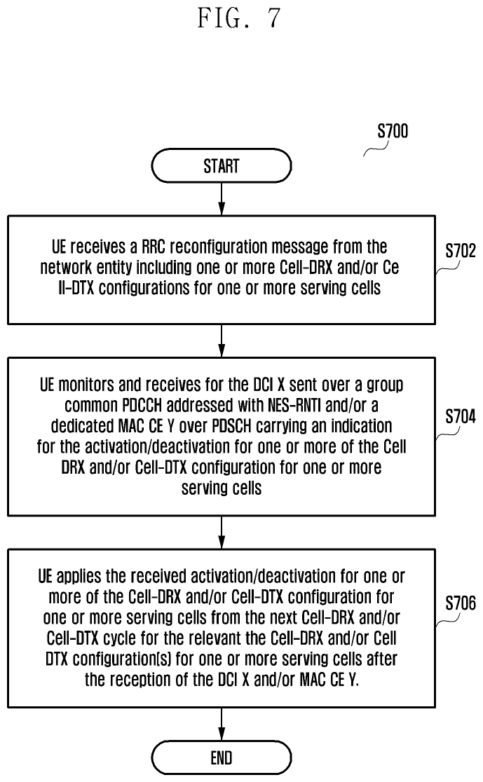

FIG. 7 is a flowchart S700 illustrating a method for receiving and applying activation/deactivation indication for a Cell-DRX and/or Cell-DTX configurations for one or more serving cells, according to an embodiment of the disclosure.

Referring to FIG. 7, at operation S702, the UE 100 receives the RRC reconfiguration message, from the network entity 200, including one or more Cell-DRX and/or Cell-DTX configurations for the one or more serving cells. At operation S704, the UE 100 monitors and receives for the DCI X sent over the group common PDCCH addressed with NES-RNTI and/or a dedicated MAC CE Y over PDSCH carrying an indication for the activation/deactivation for one or more of the Cell DRX and/or Cell-DTX configuration for one or more serving cells.

t operation S706, the UE 100 applies the received activation/deactivation for one or more of the Cell-DRX and/or Cell-DTX configuration for one or more serving cells from the next Cell-DRX and/or Cell-DTX cycle for the relevant the Cell-DRX and/or Cell DTX configuration(s) for one or more serving cells after the reception of the DCI X and/or MAC CE Y.

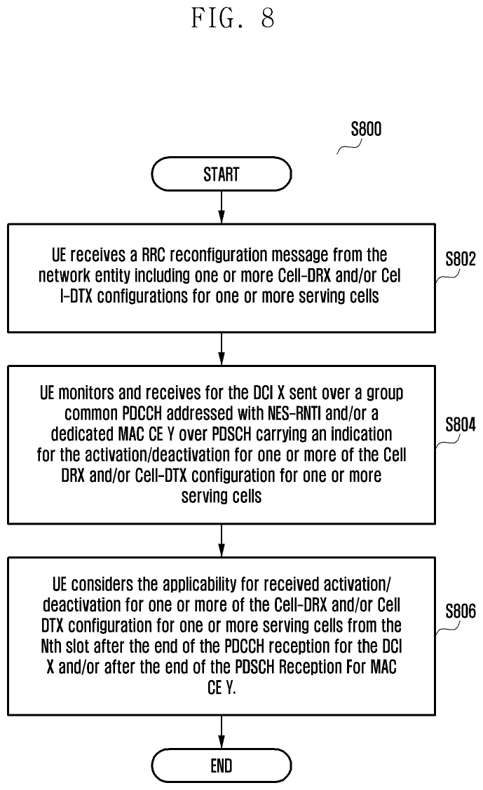

FIG. 8 is a flowchart S800 illustrating a method for receiving and applying activation/deactivation indication for a Cell-DRX and/or Cell-DTX configurations for one or more serving cells, according to an embodiment of the disclosure.

Referring to FIG. 8, at operation S802, the UE 100 receives the RRC reconfiguration message, from the network entity 200, including one or more Cell-DRX and/or Cell-DTX configurations for one or more serving cells. At operation S804, the UE 100 monitors and receives for the DCI X sent over a group common PDCCH addressed with NES-RNTI and/or a dedicated MAC CE Y over PDSCH carrying an indication for the activation/deactivation for one or more of the Cell DRX and/or Cell-DTX configuration for one or more serving cells.

At operation S806, the UE 100 considers the applicability for received activation/deactivation for one or more of the Cell-DRX and/or Cell-DTX configuration for one or more serving cells from the Nth slot after the end of the PDCCH reception for the DCI X and/or after the end of the PDSCH Reception for MAC CE Y.

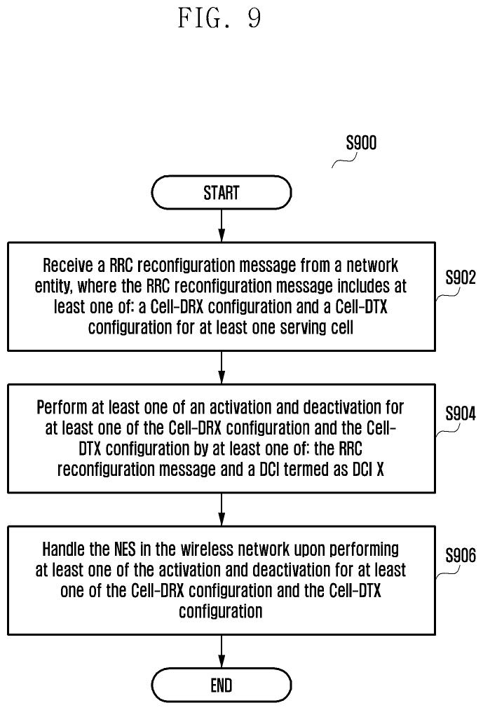

FIG. 9 is a flow chart S900 illustrating a method, implemented by a UE 100, for handling NES in a wireless network 300, according to an embodiment of the disclosure. The operations S902-S906 are handled by the NES controller 140.

Referring to FIG. 9, at operation S902, the method includes receiving the RRC reconfiguration message from the network entity 200. The RRC reconfiguration message includes at least one of: the Cell-DRX configuration and the Cell-DTX configuration for the at least one serving cell. At operation S904, the method includes performing the at least one of the activation and deactivation for at least one of the Cell-DRX configuration and the Cell-DTX configuration by at least one of: the RRC reconfiguration message and the DCI termed as DCI X. At operation S906, the method includes handling the NES in the wireless network 300 upon performing at least one of the activation and deactivation for at least one of the Cell-DRX configuration and the Cell-DTX configuration.

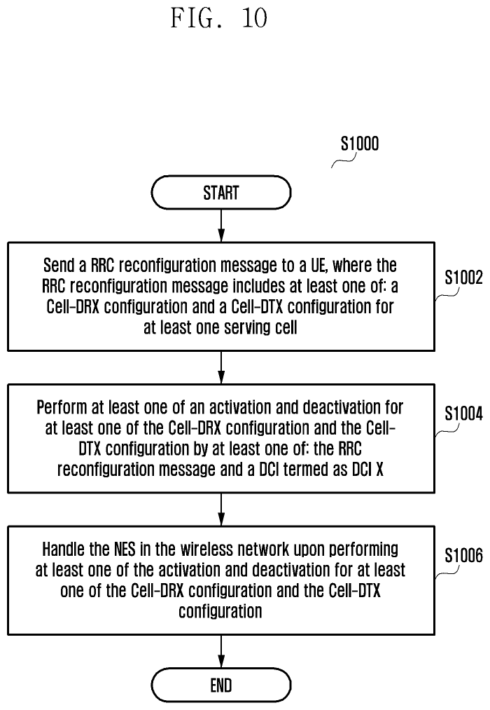

FIG. 10 is a flow chart S1000 illustrating a method, implemented by a network entity 200, for handling NES in a wireless network 300, according to an embodiment of the disclosure. The operations S1002-S1006 are handled by the NES controller 240.

Referring to FIG. 10, at operation S1002, the method includes sending the RRC reconfiguration message to the UE 100. The RRC reconfiguration message includes at least one of: the Cell-DRX configuration and the Cell-DTX configuration for at least one serving cell. At operation S1004, the method includes performing at least one of the activation and deactivation for at least one of the Cell-DRX configuration and the Cell-DTX configuration by at least one of: the RRC reconfiguration message and the DCI termed as DCI X. At operation S1006, the method includes handling the NES in the wireless network 300 upon performing at least one of the activation and deactivation for at least one of the Cell-DRX configuration and the Cell-DTX configuration.

The method can be used for signaling activation and deactivation of Cell-DTX/Cell-DRX configurations for the NES in an efficient and a reliable manner. The proposed method reduces the network energy consumption cost.

The various actions, acts, blocks, operations, or the like in the flow charts S400-S1000 may be performed in the order presented, in a different order or simultaneously. Further, in some embodiments of the disclosure, some of the actions, acts, blocks, operations, or the like may be omitted, added, modified, skipped, or the like without departing from the scope of the embodiments disclosed herein.

The embodiments disclosed herein can be implemented through at least one software program running on at least one hardware device and performing network management functions to control the elements. The elements can be at least one of a hardware device, or a combination of hardware device and software module.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a terminal in a wireless communication system, the method comprising:
receiving, from a base station, a radio resource control (RRC) message including information on a radio network temporary identity (RNTI) for network energy saving (NES) associated with discontinuous transmission (DTX)/discontinuous reception (DRX), and configuration information for least one serving cell, wherein the configuration information includes a DTX/DRX configuration for a corresponding serving cell among the at least one serving cell;
receiving, from the base station, downlink control information (DCI) scrambled with the RNTI for the NES, the DCI including a DTX/DRX indication for the corresponding serving cell; and
performing an activation or a deactivation for the DTX/DRX configuration of the corresponding serving cell, based on the DTX/DRX indication.

2. The method of claim 1,
wherein the RRC message further includes information on a size of the DCI, and
wherein information bits for the DCI are identified based on the information on the size of the DCI.

3. The method of claim 1,
wherein the configuration information further includes information on a position of a bit field for the DTX/DRX indication in the DCI,
wherein the DTX/DRX indication is identified based on the information on the position of the bit field, and
wherein a value of 0 for the bit field indicates the deactivation and a value of 1 for the bit field indicates the activation.

4. The method of claim 1,
wherein the RRC message further includes information indicating that the activation or the deactivation is to be monitored by an L1 signaling of the corresponding serving cell, and
wherein one of a DTX operation, a DRX operation or both the DTX operation and the DRX operation is activated or deactivated based on the DTX/DRX configuration.

5. The method of claim 1, further comprising:
receiving, from the base station, information on a common search space for the DCI,
wherein the activation or the deactivation for the DTX/DRX configuration is applied, after a pre-configured number of slots from a reception of the DCI.

6. A method performed by a base station in a wireless communication system, the method comprising:
transmitting, to a terminal, a radio resource control (RRC) message including information on a radio network temporary identity (RNTI) for network energy saving (NES) associated with discontinuous transmission (DTX)/discontinuous reception (DRX), and configuration information for least one serving cell, wherein the configuration information includes a DTX/DRX configuration for a corresponding serving cell among the at least one serving cell; and
transmitting, to the terminal, downlink control information (DCI) scrambled with the RNTI for the NES, the DCI including a DTX/DRX indication for the corresponding serving cell,
wherein an activation or a deactivation for the DTX/DRX configuration of the corresponding serving cell is performed in the terminal, based on the DTX/DRX indication.

7. The method of claim 6,
wherein the RRC message further includes information on a size of the DCI, and
wherein information bits for the DCI are based on the information on the size of the DCI.

8. The method of claim 6,
wherein the configuration information further includes information on a position of a bit field for the DTX/DRX indication in the DCI, and
wherein a value of 0 for the bit field indicates the deactivation and a value of 1 for the bit field indicates the activation.

9. The method of claim 6,
wherein the RRC message further includes information indicating that the activation or the deactivation is to be monitored by an L1 signaling of the corresponding serving cell, and
wherein one of a DTX operation, a DRX operation or both the DTX operation and the DRX operation is activated or deactivated based on the DTX/DRX configuration.

10. The method of claim 6, further comprising:
transmitting, to the terminal, information on a common search space for the DCI,
wherein the activation or the deactivation for the DTX/DRX configuration is applied in the terminal, after a pre-configured number of slots from a reception of the DCI.

11. A terminal in a wireless communication system, the terminal comprising:
a transceiver; and
a controller configured to:
control the transceiver to receive, from a base station, a radio resource control (RRC) message including information on a radio network temporary identity (RNTI) for network energy saving (NES) associated with discontinuous transmission (DTX)/discontinuous reception (DRX), and configuration information for least one serving cell, wherein the configuration information includes a DTX/DRX configuration for a corresponding serving cell among the at least one serving cell,
control the transceiver to receive, from the base station, downlink control information (DCI) scrambled with the RNTI for the NES, the DCI including a DTX/DRX indication for the corresponding serving cell, and
perform an activation or a deactivation for the DTX/DRX configuration of the corresponding serving cell, based on the DTX/DRX indication.

12. The terminal of claim 11,
wherein the RRC message further includes information on a size of the DCI, and
wherein information bits for the DCI are identified based on the information on the size of the DCI.

13. The terminal of claim 11,
wherein the configuration information further includes information on a position of a bit field for the DTX/DRX indication in the DCI,
wherein the controller is further configured to identify the DTX/DRX indication based on the information on the position of the bit field, and
wherein a value of 0 for the bit field indicates the deactivation and a value of 1 for the bit field indicates the activation.

14. The terminal of claim 11,
wherein the RRC message further includes information indicating that the activation or the deactivation is to be monitored by an L1 signaling of the corresponding serving cell, and
wherein one of a DTX operation, a DRX operation or both the DTX operation and the DRX operation is activated or deactivated based on the DTX/DRX configuration.

15. The terminal of claim 11,
wherein the controller is further configured to control the transceiver to receive, from the base station, information on a common search space for the DCI, and
wherein the activation or the deactivation for the DTX/DRX configuration is applied, after a pre-configured number of slots from a reception of the DCI.

16. A base station in a wireless communication system, the base station comprising:
a transceiver; and
a controller configured to:
control the transceiver to transmit, to a terminal, a radio resource control (RRC) message including information on a radio network temporary identity (RNTI) for network energy saving (NES) associated with discontinuous transmission (DTX)/discontinuous reception (DRX), and configuration information for least one serving cell, wherein the configuration information includes a DTX/DRX configuration for a corresponding serving cell among the at least one serving cell, and
control the transceiver to transmit, to the terminal, downlink control information (DCI) scrambled with the RNTI for the NES, the DCI including a DTX/DRX indication for the corresponding serving cell,
wherein an activation or a deactivation for the DTX/DRX configuration of the corresponding serving cell is performed in the terminal, based on the DTX/DRX indication.

17. The base station of claim 16,
wherein the RRC message further includes information on a size of the DCI, and
wherein information bits for the DCI are based on the information on the size of the DCI.

18. The base station of claim 16,
wherein the configuration information further includes information on a position of a bit field for the DTX/DRX indication in the DCI, and
wherein a value of 0 for the bit field indicates the deactivation and a value of 1 for the bit field indicates the activation.

19. The base station of claim 16,
wherein the RRC message further includes information indicating that the activation or the deactivation is to be monitored by an L1 signaling of the corresponding serving cell, and
wherein one of a DTX operation, a DRX operation or both the DTX operation and the DRX operation is activated or deactivated based on the DTX/DRX configuration.

20. The base station of claim 16,
wherein the controller is further configured to control the transceiver to transmit, to the terminal, information on a common search space for the DCI, and
wherein the activation or the deactivation for the DTX/DRX configuration is applied in the terminal, after a pre-configured number of slots from a reception of the DCI.
